(19) United States
(12) Patent Application Publication
(10) Pub. No.: US 2014/0084203 A1
(43) Pub. Date: Mar. 27, 2014

(54) METHOD FOR PRODUCING A MATERIAL FOR AT LEAST ANY ONE OF AN ENERGY DEVICE AND AN ELECTRICAL STORAGE DEVICE

(71) Applicants: Masayoshi Fuji, Tajimi-shi (JP); Takashi Shirai, Tajimi-shi (JP); Yuki Matsushita, Atsugi-shi (JP)

(72) Inventors: Masayoshi Fuji, Tajimi-shi (JP); Takashi Shirai, Tajimi-shi (JP); Yuki Matsushita, Atsugi-shi (JP)

(73) Assignees: TOYOTA JIDOSHA KABUSHIKI KAISHA, Toyota-shi, Aichi (JP); NATIONAL UNIVERSITY CORPORATION NAGOYA INSTITUTE OF TECHNOLOGY, Nagoya-shi, Aichi (JP)

(21) Appl. No.: 14/119,740

(22) PCT Filed: May 16, 2012
(86) PCT No.: PCT/JP2012/062552

§ 371 Date: Nov. 22, 2013

(30) Foreign Application Priority Data
May 23, 2011 (JP) 2011-114941
Nov. 24, 2011 (JP) 2011-256778

(51) Int. Cl. H01G 9/00; H01M 4/04

(52) U.S. Cl. CPC H01G 9/0029; H01M 4/0428
USPC 252/62.2; 427/126.1; 427/126.3

(57) ABSTRACT

An object of the present invention is to provide a method for producing a material for at least any one of an energy device and an electrical storage device, the method being able to form a dense nanostructure, and the material for at least any one of an energy device and an electrical storage device. Disclosed is a method for producing a material for at least any one of an energy device and an electrical storage device, the method including the steps of: treating a raw material including a vitrifiable element with alkali, and solidifying the alkali-treated raw material in a temperature condition of 15 to 30° C.

### TECHNICAL FIELD

The present invention relates to a method for producing a material for at least any one of an energy device and an electrical storage device, the method being able to form a dense nanostructure, and the material for at least any one of an energy device and an electrical storage device.

### BACKGROUND ART

A secondary battery is a battery that is able to convert chemical energy loss, which is associated with chemical reaction, into electrical energy and discharge the energy. Moreover, it is also a battery that is able to convert electrical energy into chemical energy and store (charge) the chemical energy, by passing electrical current in a direction that is opposite to the one at the time of discharge. Of secondary batteries, metal secondary batteries as typified by a lithium secondary battery have high energy density, so that they are widely used as a power source for laptop personal computers, cellular phones, etc.

Of lithium secondary batteries, a thin-film lithium secondary battery produced by thin-film technology enables a further reduction in size and weight than conventional secondary batteries. Accordingly, it is expected as a power source for IC cards and small electronic devices.

A technique to produce a thin-film lithium battery is disclosed in Patent Literature 1, which is a method for producing the cathode of a thin-film battery, comprising the steps of: forming a cathode material into a cathode active material film; annealing the film; and introducing lithium ions into the annealed film. An all-solid-state lithium secondary battery is disclosed in Patent Literature 2, which contains a garnet-type oxide layer.

A technique to produce a thin-film lithium secondary battery using a green sheet is disclosed in Patent Literature 3, which is a method for producing a full solid lithium secondary battery, comprising the steps of: forming a green sheet separately from each of a cathode active material, an anode active material and a solid electrode; stacking the thus-obtained green sheets; appropriately cutting and processing the stack; and then sintering the processed stack.

As a method for producing a film member for lithium secondary batteries, chemical vapor deposition (CVD) method, etc., are known. As a technique that uses a film forming method such as CVD, a technique to produce an anode for lithium secondary batteries is disclosed in Patent Literature 4, the anode comprising a current collector and an anode layer comprising a porous material layer, and the porous material layer being produced by introducing a lithium metal or alloy by CVD method, etc.

### CITATION LIST

Patent Literature 1: Japanese Patent Application Laid-Open (JP-A) No. 2010-27301

Patent Literature 2: JP-A No. 2010-272344

Patent Literature 3: JP-A No. 2007-80812

Patent Literature 4: JP-A No. 2011-18585

### SUMMARY OF INVENTION

### Technical Problem

In paragraph [0052] of the Description of Patent Literature 1, it is described that a cathode active material film is heated at a high temperature of 300° C. or more. In paragraph [0018] of the Description of Patent Literature 2, sintering is raised as an electrode production method. In paragraph [0050] of the Description of Patent Literature 3, it is described that sintering is conducted in the maximum temperature condition of 950° C. However, under such a high temperature condition, an unexpected side reaction may occur. Such a side reaction is promoted when, especially in the case where a by-product is thermodynamically more stable than a desired product, excess energy is applied to raw materials. In a technique that requires such a high temperature condition, battery members used for film formation must be made of materials resistant to high temperature, and this may result in narrowing the range of choices of materials for battery members. Also in such a technique that requires a high temperature condition, it is needed to use a high temperature instrument and to take into account the maintenance cost and environmental burden of the instrument.

The CVD method described in Patent Literature 4 can produce a relatively high quality film. However, the CVD method requires a vacuum condition and is thus a low-productivity method.

The present invention was achieved in light of the above circumstances. The object of the present invention is to provide a method for producing a material for at least any one of an energy device and an electrical storage device, the method being able to form a dense nanostructure, and the material for at least any one of an energy device and an electrical storage device.

### Solution to Problem

A first method for producing a material for at least any one of an energy device and an electrical storage device according to the present invention, comprises the steps of: treating a raw material comprising a vitrifiable element with alkali, and solidifying the alkali-treated raw material in a temperature condition of 15 to 30° C.

Preferably, the first production method of the present invention further comprises the step of performing a mechanochemical treatment on the raw material before the alkali treatment step.

In the first production method of the present invention, the mechanochemical treatment step is preferably a step in which ball mill treatment is used.

In the first production method of the present invention, the alkali treatment step can be a step of immersing the raw material comprising a vitrifiable element in an aqueous solution of at least one kind of lithium-containing basic material selected from the group consisting of LiOH, CH₃COOLi, Li₂CO₃ and LiAlO₂.

Preferably, the first production method of the present invention further comprises the step of applying the alkali-treated raw material to a predetermined substrate after the alkali treatment step and before the solidification step.

Preferably, the first production method of the present invention further comprises the step of cold isostatic pressing the raw material applied to the substrate, after the application step and before the solidification step.

Preferably, the first production method of the present invention further comprises the step of pre-drying the pressed raw material after the cold isostatic pressing step and before the solidification step.

Preferably, the first production method of the present invention further comprises the step of mixing the alkali-treated raw material and a non-crystalline binder before the solidification step, wherein the mixture of the alkali-treated raw material and the non-crystalline binder is solidified in a temperature condition of 15 to 30° C. at the solidification step.

In the first production method of the present invention, the vitrifiable element is preferably an element selected from the group consisting of boron, aluminum, silicon, phosphorus, vanadium, germanium, arsenic, zirconium and antimony.

In the first production method of the present invention, the raw material comprising the vitrifiable element can have a chemical composition represented by the following formula (1) or (2):

Li₁₊ₓAlₓGe₂₋ₓ(PO₄)₃ (wherein 0<x≦1) Formula (1):

Li_{y}La₃(Zr_{1-z}Nb_{z})₂O₁₂ (wherein 0<y≦10 and 0≦z<1) Formula (2):

The first production method of the present invention can be a method for producing a solid oxide electrolyte.

In the first production method of the present invention, the alkali treatment step is preferably conducted under an inert atmosphere.

A second method for producing a material for at least any one of an energy device and an electrical storage device according to the present invention, comprises the steps of: performing a mechanochemical treatment on at least an electrode active material and a raw material comprising a vitrifiable element; treating a mixture with alkali after the mechanochemical treatment step, the mixture comprising at least the electrode active material and the raw material comprising a vitrifiable element; and solidifying at least the alkali-treated mixture in a temperature condition of 15 to 30° C.

In the second production method of the present invention, an electroconductive material can be further mixed at the mechanochemical treatment step.

In the second production method of the present invention, the mechanochemical treatment step is preferably a step in which ball mill treatment is used.

In the second production method of the present invention, the alkali treatment step can be a step of immersing the mixture in an aqueous solution of at least one kind of lithium-containing basic material selected from the group consisting of LiOH, CH₃COOLi, Li₂CO₃ and LiAlO₂.

Preferably, the second production method of the present invention further comprises the step of cold isostatic pressing the alkali-treated mixture after the alkali treatment step and before the solidification step.

Preferably, the second production method of the present invention further comprises the step of pre-drying the pressed mixture after the cold isostatic pressing step and before the solidification step.

Preferably, the second production method of the present invention further comprises the step of heating the mixture comprising at least the electrode active material and the raw material comprising a vitrifiable element, after the mechanochemical treatment step and before the alkali treatment step.

In the second production method of the present invention, the mechanochemical treatment step can be a step in which the electrode active material and the raw material comprising a vitrifiable element are preliminarily mixed and then the mixture is subjected to the mechanochemical treatment.

In the second production method of the present invention, the mechanochemical treatment step can be a step of mixing the electrode active material and the raw material comprising a vitrifiable element by the mechanochemical treatment.

In the second production method of the present invention, the mechanochemical treatment step can be a step of performing a mechanochemical treatment separately on each of the electrode active material and the raw material comprising a vitrifiable element.

In the second production method of the present invention, the vitrifiable element is preferably an element selected from the group consisting of boron, aluminum, silicon, phosphorus, vanadium, germanium, arsenic, zirconium and antimony.

In the second production method of the present invention, the raw material comprising the vitrifiable element can have a chemical composition represented by the following formula (1) or (2):

Li₁₊ₓAlₓGe₂₋ₓ(PO₄)₃ (wherein 0<x≦1) Formula (1):

Li_{y}La₃(Zr_{1-z}Nb_{z})₂O₁₂ (wherein 0<y≦10 and 0≦z<1) Formula (2):

The second production method of the present invention can be a method for producing an electrode mix.

In the second production method of the present invention, the alkali treatment step is preferably conducted under an inert atmosphere.

A material for at least any one of an energy device and an electrical storage device according to the present invention, comprises crystals and a non-crystalline body, the crystals comprising a vitrifiable element and the non-crystalline body connecting the crystals.

In the material for at least any one of an energy device and an electrical storage device according to the present invention, the non-crystalline body preferably comprises a non-crystalline solid comprising a vitrifiable element.

In the material for at least any one of an energy device and an electrical storage device according to the present invention, the non-crystalline body can comprise a non-crystalline binder.

In the material for at least any one of an energy device and an electrical storage device according to the present invention, at least any one of the non-crystalline body and the crystals can comprise a vitrifiable element, comprises a solid oxide electrolyte.

In the material for at least any one of an energy device and an electrical storage device according to the present invention, the solid oxide electrolyte can have a chemical composition represented by the following formula (1) or (2):

Li₁₊ₓAlₓGe₂₋ₓ(PO₄)₃ (wherein 0<x≦1) Formula (1):

Li_{y}La₃(Zr_{1-z}Nb_{z})₂O₁₂ (wherein 0<y≦10 and 0≦z<1) Formula (2):

### Advantageous Effects of Invention

According to the present invention, it is possible to produce a material for at least any one of an energy device and an electrical storage device, which material is able to be solidified under a mild temperature condition and thus is more effective in preventing cracking, unexpected side reactions, etc., compared to conventional solidification methods in which sintering or the like is used under a high temperature condition, and has a dense nanostructure.

### BRIEF DESCRIPTION OF DRAWINGS

FIG. 1 shows schematic sectional views of the material for at least any one an energy device and an electrical storage device, in the production steps of the production method of the present invention.

FIG. 2 is a graph comparing the results of particle size distribution measurement for the solid oxide electrolytes of Example 1 and Comparative Examples 1 and 2.

FIG. 3 is a bar graph comparing the activity of the alkali-treated solid oxide electrolytes of Example 1 and Comparative Examples 1 and 2.

FIG. 4 is an SEM image of the dried solid oxide electrolyte of Example 1.

FIG. 5 is an SEM image of the dried solid oxide electrolyte of Example 3.

FIG. 6 is a graph showing the result of impedance measurement for the dried solid oxide electrolyte of Example 1.

FIG. 7 is a graph showing the result of impedance measurement for the dried solid oxide electrolyte of Example 3.

FIG. 8 is a bar graph comparing the lithium ion conductivity of the solid oxide electrolyte of Comparative Example 4, obtained by a conventional non-sintering solidification method, with that of the dried solid oxide electrolyte of Example 3.

FIG. 9 is a graph comparing the results of particle size distribution measurement for the electrode active materials of Example 4 and Comparative Examples 4 and 5.

FIG. 10 shows a graph showing the particle size distribution of LiCoO₂, which is a raw material for the electrode active material of Example 5; a graph showing the particle size distribution of LiCoO₂ of Example 5, after a ball mill treatment and before a heat treatment; and a graph showing the particle size distribution of LiCoO₂ of Example 5, after a heat treatment.

FIG. 11 is a graph obtained by stacking the following graphs: the graph showing the particle size distribution of LiCoO₂, which is a raw material for the electrode active material of Example 5; the graph showing the particle size distribution of LiCoO₂ of Example 5, after a ball mill treatment and before a heat treatment; and the graph showing the particle size distribution of LiCoO₂ of Example 5, after a heat treatment.

FIG. 12 is an image of a solidified product of the electrode mix of Example 6.

FIG. 13 is an SEM image of the dried electrode mix of Example 6.

FIG. 14 is an SEM image of the dried electrode mix of Example 7.

FIG. 15 is a graph showing the discharge curves of the batteries of Reference Examples 1 and 2 and Reference Comparative Example 1.

FIG. 16 is a graph showing the charge and discharge curves of the battery of Example 8.

FIG. 17 is a graph showing the discharge curves of Example 8, under the charge-discharge measurement conditions of 0.03 C and 0.05 C.

FIG. 18 is a graph showing the discharge curves of Example 9, under the charge-discharge measurement conditions of 0.03 C and 0.05 C.

FIG. 19 is a bar graph comparing the capacity of the battery of Comparative Example 6, comprising a cathode mix produced by a conventional sintering method, with the capacity of the battery of Example 8.

FIG. 20 shows a TEM image of the solid oxide electrolyte of Example 10 and a schematic view representing the composition distribution inside the solid oxide electrolyte, based on the TEM image.

FIG. 21 is a graph showing the XRD spectrum of the solid oxide electrolyte of Example 10, the XRD spectrum of the solid oxide electrolyte of Reference Example 3, and the XRD spectrum of Li_{1.5}Al_{0.5}Ge_{1.5}(PO₄)₃, which is a solid oxide electrolyte.

FIG. 22 is a graph showing the lithium ion conductivity of the solid oxide electrolyte of Example 10 and that of the solid oxide electrolyte of Reference Example 3.

FIG. 23 is a schematic sectional view of a solid crystal film formed by a conventional casting method.

FIG. 24 is a bar graph comparing the lithium ion conductivity of the solid electrolyte obtained by a conventional non-sintering solidification method with that of the solid electrolyte obtained by a powder compaction sintering method.

FIG. 25 is an SEM image of the dried solid oxide electrolyte of Comparative Example 2.

FIG. 26 shows a TEM image of the solid oxide electrolyte of Reference Example 3 and a schematic view representing the composition distribution inside the solid oxide electrolyte, based on the TEM image.

### DESCRIPTION OF EMBODIMENTS

### 1. First Method for Producing a Material for at Least Any One of an Energy Device and an Electrical Storage Device

The first production method of the present invention relating to a material for at least any one of an energy device and an electrical storage device (hereinafter the material may be referred to as “material for devices”) comprises the steps of treating a raw material comprising a vitrifiable element with alkali (alkali treatment step) and solidifying the alkali-treated raw material in a temperature condition of 15 to 30° C. (solidification step).

In the present invention, “energy device” means a device which is able to supply energy. As used herein, the term “energy” encompasses both of physical energy and chemical energy. Concrete examples of physical energy include mechanical energy, thermal energy, light energy, electrical energy and atomic energy. Examples of chemical energy include Helmholtz energy, Gibbs energy and ionization energy. It is preferable that “energy device” as used herein is a device that is also able to store energy. Examples of energy devices include thermoelectric conversion elements, piezoelectric elements, and batteries such as the below-described secondary battery.

As used herein, the term “electrical storage device” a device which is able to store at least electrical energy. The electrical storage device is preferably a device which is also able to discharge. Examples of electrical storage devices include primary battery, secondary battery, fuel cell, capacitor, biological battery, solar battery (photoelectric element) and nuclear battery.

The material produced by the present invention can be a material for an energy device, a material for an electrical storage device, or a material for a device which functions as both an energy device and an electrical storage device.

Known film forming methods for forming a material for devices (e.g., battery) into a film, include the sintering method, the CVD method, the aerosol deposition (AD) method, the pulse laser deposition (PLD) method and the three dimensionally ordered macroporous (3DOM) method, for example.

The sintering method requires a high temperature condition, so that it has the following problems: a side reaction occurs; there is a limitation on the type of materials that can be used, making it not always possible to use high-capacity, high-power materials; sintering equipment is needed; and environmental burdens are caused by the sintering equipment. Especially in the case of sintering a mixture of two or more kinds of materials with different properties, an unexpected chemical reaction is caused between the materials with different properties and results in production of a by-product; therefore, there may be a deterioration in the performance of the material for devices. Accordingly, in the case of sintering a mixture of two or more kinds of materials with different properties, it is needed to choose a combination of materials which are not reactive with each other even at a sintering temperature, and the range of material choices is further narrowed.

The CVD method requires a vacuum condition to prevent incorporation of impurities. Film formation under such a vacuum condition suffers from slow film formation rate.

The AD method is a method that allows film formation under a lower vacuum condition than the CVD method. However, the AD method is a method for forming a film by applying a raw material like spraying, so that 90% or more of the raw material is not formed into a film and there is a problem of poor production efficiency. The CVD, AD and PLD methods are only applicable to the production of a film from a single material, so that they cannot produce a layer from a mixture of materials and have difficulty in producing a battery with high energy density.

Methods such as a slurry applying method and a casting method are generally known as film forming methods that do not require a high temperature condition.

The slurry applying method is a method that enables the production of the material for devices even at ordinary temperature, by mixing a material to be applied with a binder to make a slurry, and then appropriately applying the slurry to a substrate, etc. However, the slurry applying method is problematic in that there is a decrease in energy density by the addition of the binder. Especially in the case of a material with high hardness, even if the applied slurry is pressed, no densification of the material is achieved and there is no sufficient increase in the area of contact between substances in the material (the area of an interface between the substances). Accordingly, when two or more kinds of materials with different properties are mixed and the slurry is applied and pressed, there is an increase in the resistance of the interface between the different kinds of materials, and the thus-obtained material for devices is not a high-performance material, therefore.

For the casting method, film-forming examples using ceramic materials such as silica (SiO₂) and a mixture of silica and alumina (SiO₂/Al₂O₃) are known; however, no cases are known in which the casting method is applied to film formation using the material for devices.

A reason why the conventional casting method is not applied to the material for devices is that film formation by the casting method has been considered unsuitable for construction of a dense nanostructure. The chemical structure constructed by the conventional casting method is a rough structure, so that it cannot satisfy the functions required of the material for devices, such as electroconductivity, ion conductivity and gas diffusibility, and is not suitable for practical use.

In the case of using solid crystals as the material for devices, the conventional casting method has a problem that is provides poor contact between the solid crystals. FIG. 23 is a schematic sectional view of a solid crystal film formed by the conventional casting method. As shown in FIG. 23, the solid crystal film 200 produced by the conventional casting method is a film made of solid crystals 1. The solid crystals 1 have moderate hardness and poor flexibility. Accordingly, the solid crystals 1 are in contact with each other only at contact points 2 (point contact). Therefore, the solid crystal film 200 formed by the conventional casting method has poor contact between the crystals and is thus poor in not only functions required of the material for devices, such as electroconductivity, but also poor in physical properties such as cracking.

The inventors of the present invention have found a novel method for solidifying a material at ordinary temperature, in which a material can be solidified at ordinary temperature by preliminarily treating a raw material comprising a vitrifiable element with alkali and thus activating the raw material. The inventors have found that the novel method is more effective in preventing cracking, unexpected side reactions, etc., than conventional solidification methods in which sintering or the like is used under a high temperature condition, and is able to form a dense nanostructure. Based on the knowledge, they completed the present invention.

Examples of materials for secondary batteries include an electrode active material contained in an electrode and an electrolyte incorporated in an electrode or sandwiched between electrodes for use. By applying the present invention to an electrolyte for secondary batteries, especially to a solid electrolyte, ion conductivity of the solid electrolyte can be increased. By applying the present invention to an electrode active material for secondary batteries, it is possible to increase electroconductivity and ion conductivity of the electrode active material, to increase charge-discharge capacity of a battery, and to reduce resistance of a battery.

Examples of materials for fuel cells include an electrode catalyst contained in an electrode and an electrolyte incorporated in an electrode or sandwiched between electrodes for use. By applying the present invention to an electrolyte for fuel cells, especially to a solid polymer electrolyte, ion conductivity of the solid polymer electrolyte can be increased. By applying the present invention to an electrode catalyst for fuel cells, it is possible to increase electroconductivity and ion conductivity of the electrode catalyst, to increase charge-discharge capacity of a battery, and to reduce resistance of a battery.

The first production method of the present invention comprises (1) the step of treating a raw material with alkali, and (2) the step of solidifying the alkali-treated raw material. The present invention is not limited to the two steps, and may comprise a mechanochemical treatment step and application step as described below, for example.

Hereinafter, the step (1), the step (2) and other steps will be explained in order.

1-1. Step of Treating the Raw Material with Alkali

The step is a step of treating a raw material comprising a vitrifiable element with alkali.

In this step, “raw material comprising a vitrifiable element” is a material that satisfies the following three conditions: (1) a vitrifiable element is present as a constituent element; (2) the constituent element is dissociated by adding an alkali solution; and (3) the dissociated element causes a dehydration-condensation reaction upon drying the alkali solution.

Concrete examples of vitrifiable elements include boron, aluminum, silicon, phosphorus, vanadium, germanium, arsenic, zirconium and antimony. The raw material used in this step preferably contains one or more of these elements.

The raw material comprising the vitrifiable element can have a chemical composition represented by the following formula (1) or (2):

Li₁₊ₓAlₓGe₂₋ₓ(PO₄)₃ (wherein 0<x≦1) Formula (1):

Li_{y}La₃(Zr_{1-z}Nb_{z})₂O₁₂ (wherein 0<y≦10 and 0≦z<1) Formula (2):

Of the above-mentioned element examples, aluminum and germanium are contained in the chemical composition represented by the formula (1). Of the above-mentioned element examples, zirconium is contained in the chemical composition represented by the formula (2).

Raw materials comprising a vitrifiable element can be used alone or in combination of two or more kinds.

The alkali treatment step is a step of bringing the raw material comprising a vitrifiable element into contact with a basic material. Through this step, the raw material comprising a vitrifiable element is activated by hydrolysis.

The basic material may be solid, liquid or gaseous. When the basic material is liquid at ordinary temperature (15 to 30° C.), the alkali treatment is completed by immersing the raw material comprising a vitrifiable element in the liquid for a predetermined time. When the basic material is gaseous at ordinary temperature, the alkali treatment is completed by spraying the gas to the raw material comprising a vitrifiable element for a predetermined time. When the basic material is solid at ordinary temperature, the alkali treatment is completed by dissolving the solid in an appropriate solvent such as pure water or alcohol (e.g., methanol, ethanol) or a mixed solvent thereof, and then immersing the raw material comprising a vitrifiable element in the solution for a predetermined time.

The alkali treatment time is preferably 3 to 300 minutes. If the alkali treatment time is less than 3 minutes, due to insufficient hydrolysis, activation of the raw material may not be enough. If the alkali treatment time is more than 300 minutes, due to the too long alkali treatment time, in the case of using an aqueous solution of a basic material for example, water is vaporized by drying; therefore, a dehydration-condensation reaction occurs directly between the basic material and the raw material comprising a vitrifiable element, which may cause a part of the raw material to be vitrified and solidified prior to subsequent steps.

The basic material used is preferably a basic aqueous solution, because such a solution makes it simple to perform the alkali treatment.

In the case of using a liquid such as a basic aqueous solution as the basic material, it is preferable to sufficiently stir the liquid and the raw material comprising a vitrifiable element to mix them well. The stirring method is not particularly limited and may be a conventional stirring method.

By the alkali treatment step, part of the raw material comprising a vitrifiable element is dissolved in the liquid. The dissolved liquid can be confirmed by measuring the alkali-treated liquid by inductively coupled plasma mass spectrometry (hereinafter may be referred to as ICP-MS), for example.

As the basic aqueous solution, a basic aqueous solution containing a lithium salt can be used. The alkali treatment with an aqueous solution of a lithium salt is particularly preferable in the case where a lithium element is contained in the raw material comprising a vitrifiable element.

As the lithium salt contained in the basic, lithium salt aqueous solution, there may be mentioned LiOH, CH₃CO0Li, Li₂CO₃ and LiAlO₂, for example. These lithium salts can be used alone or in combination of two or more kinds.

The concentration of the lithium salt in the basic, lithium salt aqueous solution is preferably in the range of 0.25 to 5 mol/L.

The amount of the basic aqueous solution added can be appropriately controlled in light of the effect of the solution on the steps after the alkali treatment.

For example, in the case of using a lithium hydroxide aqueous solution for the alkali treatment, if casting is scheduled after the alkali treatment, the content ratio of the lithium hydroxide aqueous solution is preferably 0.003 to 50% by mass, based on the total mass of the raw material comprising a vitrifiable element and the lithium hydroxide aqueous solution of 100% by mass. When the content ratio is more than 50% by mass, the content ratio of the lithium hydroxide aqueous solution is too high and may result in the formation of a solidified product having a sparse structure after dehydration-condensation. Or, high levels of stress occur upon drying and may break the solidified product thus formed.

Also in the case of using a lithium hydroxide aqueous solution for the alkali treatment, if application of the alkali-treated raw material is scheduled after the alkali treatment, the content ratio of the lithium hydroxide aqueous solution is preferably 50 to 99.997% by mass, based on the total mass of the raw material comprising a vitrifiable element and the lithium hydroxide aqueous solution is 100% by mass. When the content ratio is less than 50% by mass, the content of the lithium hydroxide aqueous solution is too low and thus the alkali-treated raw material fails to be in slurry form, which may make the application difficult.

The alkali treatment step is preferably conducted under an inert atmosphere. As used herein, “under an inert atmosphere” means “in the presence of an inert gas such as nitrogen or argon”.

When the alkali treatment is conducted under the air atmosphere, by-product impurities including an oxide such as GeO₂ may be produced inside the alkali-treated material for devices. The material for devices containing such impurities may, when used for an energy device or electrical storage device, deteriorate the performance of these devices. For example, a lithium battery produced with the material for devices containing such impurities, may have poor lithium ion conductivity. The reason for the production of such by-product impurities including an oxide, is as follows: due to high reactivity between oxygen in the air and ions of the vitrifiable element (such as germanium ion) dissolved in the basic material during the alkali treatment, an oxide of the vitrifiable element is preferentially produced as a by-product.

Accordingly, when conducting the alkali treatment, the production of by-product impurities including an oxide can be prevented by eliminating oxygen in the atmosphere as much as possible.

It is preferable to perform a mechanochemical treatment on the raw material comprising a vitrifiable element before the alkali treatment step. As just described, by imparting physical energy to the raw material comprising a vitrifiable element and thus non-crystallizing at least the surface of the raw material solid, hydrolysis can be promoted quickly in the succeeding alkali treatment step.

Examples of the mechanochemical treatment include mechanical milling, bead milling, etc.

Especially, mechanical milling is not particularly limited as long as it is a method for imparting mechanical energy to the raw material comprising a vitrifiable element. For example, there may be mentioned a ball mill, a turbo mill, mechanofusion and a disk mill. Of them, preferred is a ball mill, and particularly from the viewpoint of efficient process of the non-crystallization, a planetary ball mill is preferred.

The conditions of the mechanical milling are preferably conditions under which the raw material comprising a vitrifiable element is sufficiently ground until the average particle size of the raw material comprising a vitrifiable element becomes the minimum and the particle size distribution of the raw material does not vary. For example, in the case of non-crystallization of the raw material comprising a vitrifiable element with a planetary ball mill, the raw material and grinding balls are put in a pot and processed at a predetermined rotational frequency and time. In general, the higher the rotational frequency, the faster the non-crystallization of the raw material; moreover, the longer the processing time, the higher the ratio of non-crystallized particles in the raw material. In the case of using a planetary ball mill, the rotational frequency is in the range of 150 to 1000 rpm for example, preferably in the range of 200 to 500 rpm. The processing time is in the range of 10 minutes to 100 hours for example, preferably in the range of 30 minutes to 50 hours.

The period between the mechanical milling and the alkali treatment is preferably 3 days or less. When more than 3 days have elapsed after the mechanical milling, the surface of the raw material comprising a vitrifiable element returns to the state before the mechanical milling, that is, an inert state. Accordingly, when the raw material is left for more than 3 days after the mechanical milling, the number of active points on the surface of the raw material comprising a vitrifiable element decreases and may result in insufficient progression of dehydration-condensation in the succeeding solidification step.

### 1-2. Step of Solidifying the Alkali-Treated Raw Material

This step is a step of solidifying the raw material comprising a vitrifiable element treated with alkali (hereinafter it may be referred to as “alkali-treated raw material”) in a temperature condition of 15 to 30° C.

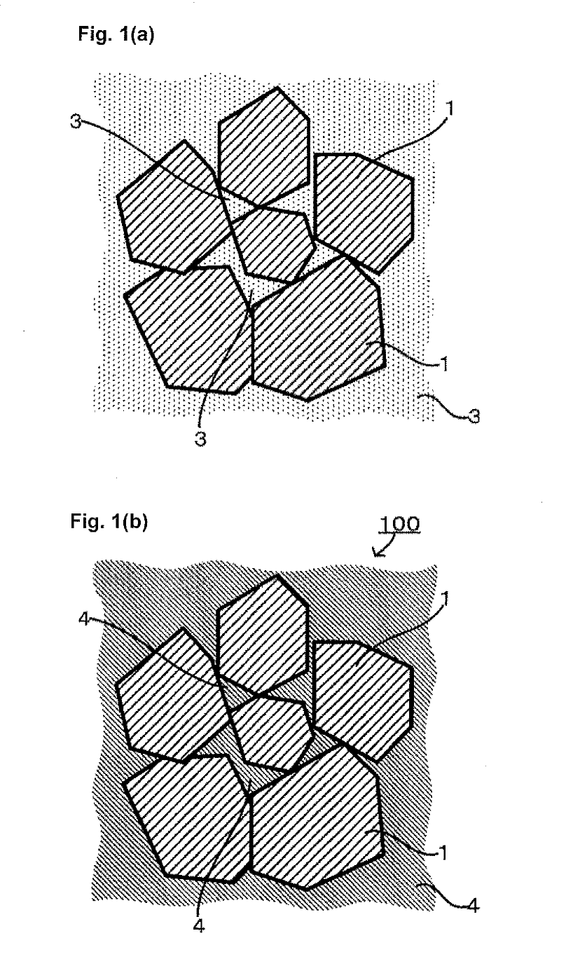

FIG. 1 shows schematic sectional views of the material for devices, in the production steps of the production method of the present invention.

FIG. 1(a) is a schematic sectional view of the alkali-treated raw material. After the alkali treatment, solid crystals 1 are surrounded by a mixture 3 of the basic material and the raw material eluted from the crystals.

FIG. 1(b) is a schematic sectional view of the solidified material for devices. A solid crystal film 100 solidified by this step is a film containing the solid crystals 1 and the raw material reprecipitated (reprecipitated raw material 4). The solid crystals 1 have moderate hardness and poor flexibility. However, gaps between the solid crystals 1 are filled by the reprecipitated raw material 4, and due to the reprecipitated raw material 4, the solid crystals 1 are connected to each other by chemical bonding. Therefore, the solid crystal film 100 formed by the production method of the present invention has dense contact between the solid crystals and is thus excellent in functions required of the material for devices, such as electroconductivity, ion conductivity and gas diffusivity.

It is a main characteristic of the present invention that the temperature required for solidification is in the range of 15 to 30° C., which is known as a range of ordinary temperature.

In the present invention, by solidification at ordinary temperature, a dehydration-condensation reaction is gradually developed and makes it possible to obtain a rigid solidified product. The present invention does not require a high temperature condition, so that it is possible to avoid the problem of occurrence of unexpected side reactions under a high temperature condition. In addition, there is no possibility that the temperature condition affects the performance of the material for devices, so that it is possible to expand the range of choices of the materials. Moreover, there is no need to prepare a special temperature environment, so that it is possible to reduce production and equipment costs more than ever before.

The alkali-treated raw material can be left and dried under the air, as long as the above temperature condition is satisfied. However, it is preferable that the alkali-treated raw material is left and dried under an inert atmosphere. Also, the alkali-treated raw material can be dried with a drier or the like, or can be dried under reduced pressure. The method for solidifying the alkali-treated raw material is not particularly limited as long as the method can remove volatile impurities such as a solvent.

In the solidification step, the solidification temperature is preferably 18 to 27° C., more preferably 20 to 25° C.

Before the solidification step, the alkali-treated raw material can be processed in any manner. In particular, the alkali-treated raw material can be solidified after casting, or it can be solidified after it is applied to a predetermined substrate. No matter how the alkali-treated raw material is processed, it is possible to solidify the raw material at 15 to 30° C., which is so-called ordinary temperature, as long as the raw material is kept in a state of activation, so that the processing method is not particularly limited.

The casting is not particularly limited as long as it is a method such that the alkali-treated raw material is put in a predetermined mold and pressed with a pressing machine. Casting conditions are mentioned below; however, the casting is not limited to the following conditions.

Press pressure: Preferably 1 to 20 MPa, more preferably 5 to 10 MPa

Pressing time: One minute

Pressing machine: Uniaxial pressing machine, cold isostatic pressing (CIP) machine, etc.

The predetermined substrate used for application of the raw material is not particularly limited as long as a flat surface can be used for solidification. As just described, a film can be produced just by applying the raw material to a flat surface, so that it is possible to simplify the production process.

Examples of application methods include, but not limited to, a spraying method, a screen printing method, a doctor blade method, a gravure printing method, a die coating method and a spin coater method.

Preferably, cold isostatic pressing (hereinafter referred to as CIP) is performed on the casted material or on the raw material applied to the substrate, after the above-described casting or after the application step and before the solidification step.

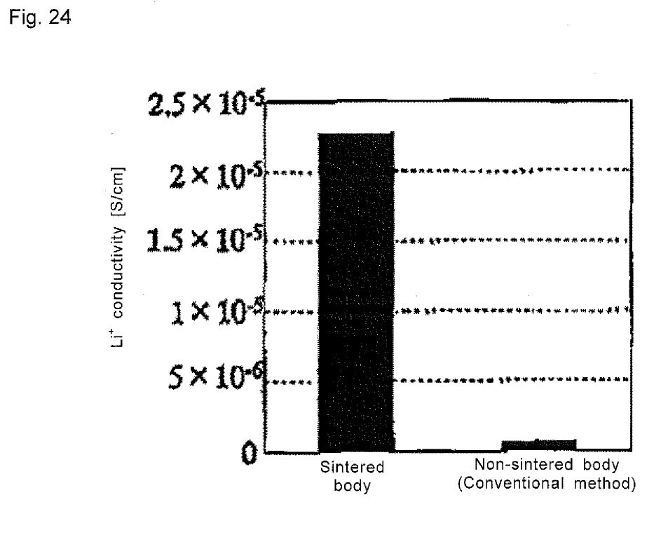

FIG. 24 is a bar graph comparing the lithium ion conductivity of the solid electrolyte obtained by a conventional non-sintering solidification method with that of the solid electrolyte obtained by a powder compaction sintering method. As is clear from FIG. 24, the conventional solid electrolyte obtained by solidification and not using sintering, has a lithium ion conductivity of 6.89×10⁻⁷ (S/cm) (see the right bar). On the other hand, the solid electrolyte obtained by the powder compaction sintering method has a lithium ion conductivity of 2.27×10⁻⁵ (S/cm) (see the left bar). Accordingly, the lithium ion conductivity of the solid electrolyte obtained by the conventional non-sintering solidification method is about 3% of the lithium ion conductivity of the solid electrolyte obtained by the powder compaction sintering method.

In the case of the conventional non-sintering solidification method, the thus-produced material for devices has low crystal density; therefore, a non-crystalline body accounts for about 15% of the material for devices, which is poor in lithium conductivity than crystalline body. Also, there is sometimes a case that pores in which a non-crystalline body is not present, are formed.

In the case of general uniaxial pressing, the basic material added may leak. For example, in the case of uniaxial pressing in a vertical direction, the basic material may leak in a horizontal direction. Accordingly, the basic material supplied to the material for devices is not enough and causes the formation of pores. Also in the case of general uniaxial pressing, the pressure the pressing can apply is as low as about several tens of MPa, so that the pressing is problematic in that crystals cannot be aligned so as to have a dense structure.

The inventors of the present invention have found out that by conducting TIP prior to the non-sintering solidification and after the casting or application, it is possible to spread the basic material throughout the material for devices and to increase the crystal density and bring the crystals close to each other; therefore, it is possible to eliminate pores from the material for devices and to decrease the ratio of the non-crystalline body lower than ever before.

CIP can apply pressure equally from all directions and is thus able to disperse the basic material added in the material for devices. Therefore, no pores are formed in the material for devices. The pressure CIP can apply is several hundreds of MPa and this value is more than 10 times higher the pressure the uniaxial pressing can apply; therefore, it is possible to bring the crystals in the material for devices sufficiently close to each other and thus to form dense lithium conducting paths.

The pressure used for CIP is preferably 20 to 400 MPa. When the pressure is less than 20 MPa, the pressure is too small and it is thus difficult to increase the crystal density in the material for devices. On the other hand, when the pressure used for CIP is more than 400 MPa, the pressure is too high and thus the material molded may crack.

Examples of devices which can use for CIP include DR. PIP (product name; manufactured by KOBELCO) and CPA-50 (product name; manufactured by Sansho Industry Co., Ltd.)

CIP can be conducted in the casting step. That is, the casting and CIP can be conducted at once.

It is preferable to pre-dry the pressed raw material after the CIP step and before the solidification step. By pre-drying like this, cracking due to drying can be prevented during the main drying. In the pre-drying step, it is preferable to dry the pressed raw material under a high humidity condition, more specifically, under the condition of a relative humidity of 50 to 100%. It is also preferable that the pre-drying step is conducted under an inert atmosphere.

The production method of the present invention can further comprises the step of mixing the alkali-treated raw material and a non-crystalline binder before the solidification step to solidify the mixture of the alkali-treated raw material and the non-crystalline binder in a temperature condition of 15 to 30° C. at the solidification step.

The mixing with the non-crystalline binder is not particularly limited as long as it is conducted after the alkali treatment and before the solidification step.

The non-crystalline binder is not particularly limited as long as it is one that can be generally used as a binder. Examples of non-crystalline binders that can be used in the present invention include rubber-based binders, particles of acrylonitrile rubber such as BM-500B, and styrene-butadiene rubber.

The production method of the present invention allows production under the air, so that it can be applied to the production of a film particularly containing an oxide material. As used herein, “oxide material” encompasses solid oxide electrolytes, ceramic condensers, high-temperature superconducting ceramics, etc.

### 2. Second Method for Producing a Material for at Least Any One of an Energy Device and an Electrical Storage Device

The second method according to the present invention for producing a material for at least any one of an energy device and an electrical storage device, comprises the steps of performing a mechanochemical treatment on at least an electrode active material and a raw material comprising a vitrifiable element (mechanochemical treatment step); treating a mixture with alkali after the mechanochemical treatment step, the mixture comprising at least the electrode active material and the raw material comprising a vitrifiable element (alkali treatment step); and solidifying at least the alkali-treated mixture in a temperature condition of 15 to 30° C. (solidification step).

The second production method comprises (1) the mechanochemical treatment step, (2) the step of treating the mixture with alkali, and (3) the step of solidifying the alkali-treated mixture. The present invention is not limited to these, three steps and can further comprise, for example, the below-described casting step.

The above steps (2) and (3) of the second production method, that is, the step of treating the mixture with alkali and the step of solidifying the alkali-treated mixture, correspond to those of the first production method, that is, the step of treating the raw material with alkali and the step of solidifying the alkali-treated raw material, respectively. The mechanochemical treatment step of the second production method corresponds to the mechanochemical treatment step which is preferably conducted in the first production step.

Hereinafter, the steps (1) to (3) and other steps will be explained in order.

### 2-1. Mechanochemical Treatment Step

This step is a step of performing a mechanochemical treatment on at least an electrode active material and a raw material comprising a vitrifiable element.

The raw material comprising a vitrifiable element used in this step is the same as that of the above-described first production method. Accordingly, the vitrifiable element is preferably an element selected from the group consisting of boron, aluminum, silicon, phosphorus, vanadium, germanium, arsenic, zirconium and antimony. Also, the raw material comprising the vitrifiable element can have the above-described chemical composition represented by the above-described formula (1) or (2).

The electrode active material used in this step is a material that is used for electrodes of a battery, and it is also a material which directly relates to electrode reaction. “Electrode active material” as used herein encompasses a cathode active material and an anode active material.

Cathode active materials for lithium batteries include LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃ and Li₃V₂(PO₄)₃. Anode active materials for lithium batteries are not limited as long as they are able to store and release lithium ions. Examples thereof include lithium metals, lithium alloys, metal oxides containing a lithium element, metal sulfides containing a lithium element, metal nitrides containing a lithium element, and carbonaceous materials such as graphite.

The electrode active material used in the present invention is not limited to an electrode active material for lithium batteries, and there may be also mentioned an electrode catalyst for fuel batteries and an electrode active material for air batteries, for example.

The mechanochemical treatment used in this step is the same as that of the above-described first production method. Even in this step, as with the first production method, the mechanochemical treatment is preferably a ball milling treatment.

The mechanochemical treatment of this step is a step of activating the raw material comprising a vitrifiable element and grinding the electrode active material finer. By activating the raw material comprising a vitrifiable element, the vitrifiable element eluted from the raw material forms glass between the materials constituting the mixture and serves as a factor in forming a solidified product. Also, by imparting energy to the raw material comprising a vitrifiable element by the mechanochemical treatment and activating and non-crystallizing the surface of the raw material, it is possible to elute the vitrifiable element from the part activated and amophized.

The type, detailed treatment conditions, etc., of the mechanochemical treatment are the same as those of the above-described first production method. In this step, the electrode active material and the raw material comprising a vitrifiable element can be preliminarily mixed and then subjected to the mechanochemical treatment, or the electrode active material and the raw material comprising a vitrifiable element can be supplied to a mechanochemical treatment device each and then mixed by the mechanochemical treatment. Or, as shown below under “Examples”, each of the materials can be subjected to the mechanochemical treatment separately and then mixed together.

An electroconductive material can be further mixed at the mechanochemical treatment step. The electroconductive material is a material which imparts electroconductivity to the mixture. Examples of electroconductive materials that can be used in this step include carbon blacks such as acetylene black and Ketjen Black, and vapor-grown carbon fibers (VGCF).

The solidified product mixed with an electroconductive material such as VGCF is fragile, so that it is difficult to conduct non-sintering solidification of such a solidified product in conventional methods for producing materials for devices. In this second production method, however, it is possible to form the solidified product containing an electroconductive material such as VGCF, by grinding the electrode active material finer by the mechanochemical treatment.

In this step, by the mechanochemical treatment, it is preferable to set the frequency of particle size of 1 μm or less in the particle size distribution of the electrode active material, to 20% or more.

Preferably, the second production method of the present invention further comprises the step of heating the mixture comprising at least the electrode active material and the raw material comprising a vitrifiable element, after the mechanochemical treatment step and before the alkali treatment step. When the mechanochemical treatment is separately performed on each of the electrode active material and the raw material comprising a vitrifiable element, each of the materials can be separately heated.

The above-described mechanochemical treatment grinds the electrode active material finer; moreover, depending on the treatment conditions, the outermost surface of the electrode active material is vitrified and may result in a decrease in crystallinity of the outermost surface. This phenomenon is caused by physical energy applied to the electrode active material from a grinding medium such as grinding balls in the mechanochemical treatment. Such an electrode active material with decreased crystallinity of the outermost surface, may be inferior in electrode active material characteristics compared to an electrode active material not subjected to the mechanochemical treatment, especially in a metal ion transfer characteristic, etc.

Accordingly, in this step, by heating the mixture containing the electrode active material subjected to the ball mill treatment, vitrified parts of the electrode active material are recrystallized, while the activation state is maintained; therefore, it is possible to recover the electrode active material characteristics and to increase the performance of a battery comprising the electrode active material. Especially, as shown in Example 9 explained below, the inventors have found that in a battery comprising such a heat-treated electrode mix, there is an increase in discharge capacity and usage at both high and low rates.

The heat treatment step is preferably conducted under an inert atmosphere. A concrete example of the heat treatment is a heat treatment inside a glove box filled with an inert gas.

Typical examples of heat treatment conditions are explained below. However, the heat treatment of the present invention is not limited to the following typical examples.

Temperature: 600 to 1,000° C.

Time: 1 to 10 hours

Atmosphere: Inert gas such as argon or nitrogen

The moisture contained in the inert gas is preferably as small as possible.

It can be confirmed whether recrystallization of the electrode active material surface is promoted by the heat treatment or not, by producing a battery using an electrode which is made of only the electrode active material subjected to the heat treatment and then by charge-discharge measurement of the battery. An example is as follows: first, an electrode active material subjected to the heat treatment is prepared, as well as an electrode active material not subjected to the heat treatment; a battery is produced using an electrode made of only the electrode active material subjected to the heat treatment, and another battery is produced using an electrode made of only the electrode active material not subjected to the heat treatment; next, discharge measurement is performed on these two kinds of batteries, and when the discharge capacity of the battery using the electrode active material subjected to the heat treatment, is larger than the discharge capacity of the battery using the electrode active material not subjected to the heat treatment, it can be determined that recrystallization of the electrode active material surface is promoted by the heat treatment.

2-2. Step of Treating the Raw Material with Alkali

This step is a step of treating the mixture comprising at least the electrode active material and the raw material comprising a vitrifiable element, with alkali, after the mechanochemical treatment step.

In this step, by adding a basic material to preferably the mixture of the raw materials dispersed under a dry atmosphere, the raw material comprising a vitrifiable element is dispersed throughout the mixture and the vitrifiable element can be eluted into the whole basic material from non-crystallized parts of the material.

The principle of the alkali treatment, the detailed treatment conditions, the basic material used for the alkali treatment, etc., are the same as those of the above-described first production method. As well as the first production step, this step can be a step of immersing the mixture comprising at least the electrode active material and the raw material comprising a vitrifiable element in an aqueous solution of at least one kind of lithium-containing basic material selected from the group consisting of LiOH, CH₃COOLi, Li₂CO₃, LiAlO₂, etc.

Before the solidification step, for example, casting can be performed on the alkali-treated mixture. No matter how the alkali-treated mixture is processed, it is possible to solidify the raw material comprising a vitrifiable element at 15 to 30° C., which is so-called ordinary temperature, as long as the raw material is kept in a state of activation, so that the processing method is not particularly limited. The casting conditions are the same as those of the above-described first production method.

Preferably, the second production method of the present invention comprises the step of cold isostatic pressing (CIP) the alkali-treated mixture after the alkali treatment step and before the below-described solidification step. By CIP, it is possible to spread the basic material throughout the mixture. The details of CIP are the same as those of the above-described first production method.

CIP can be conducted after casting, from the point of view that it is possible to adjust the shape of the mixture by casting and then to spread the basic material throughout the mixture by CIP.

It is preferably to pre-dry the pressed mixture after the CIP step and before the solidification step. It is more preferable that the pre-drying is conducted under an inert atmosphere. By the pre-drying, cracking due to drying can be prevented in the main drying. The pre-drying conditions are the same as those of the above-described first production method.

### 2-3. Step of Solidifying the Alkali-Treated Raw Material

This step is a step of solidifying at least the alkali-treated mixture in a temperature condition of 15 to 30° C.

In this step, a dehydration-condensation is promoted between the materials which constitute the mixture by drying to solidify the whole mixture. The principle of the solidification step, the detailed solidification conditions, etc., are the same as those of the above-described first production method.

The vitrifiable element eluted from the raw material comprising a vitrifiable element forms glass between the material and the electrode active material; therefore, it is possible to increase the contact area between the material and the electrode active material and thus to decrease the interface resistance between the material and the electrode active material.

The second production method of the present invention is particularly suitable for the production of an electrode mix, from the viewpoint of being able to produce a uniform and dense solidified product by combining two or more kinds of materials. As used herein, “electrode mix” means a mix which is used for an electrode of a battery.

### 3. Material for at Least Any One of an Energy Device and an Electrical Storage Device

The material for at least any one of an energy device and an electrical storage device according to the present invention, comprises crystals and a non-crystalline body, the crystals comprising a vitrifiable element and the non-crystalline body connecting the crystals.

In the present invention, the crystals comprising a vitrifiable element are crystals derived from the raw material comprising a vitrifiable element used in the above-described production method.

In the present invention, the non-crystalline body can be a non-crystalline body which comprises a non-crystalline solid comprising a vitrifiable element, or it may be the non-crystalline binder used in the above-described production method. Also in the present invention, the non-crystalline body can comprise a non-crystalline polymer compound.

It is preferable that at least any one of the non-crystalline body and the crystals comprising a vitrifiable element, both of which are contained in the material for devices according to the present invention, comprises a solid oxide electrolyte. The solid oxide electrolyte can have a chemical composition represented by the above-described formula (1) or (2).

The material for devices according to the present invention can be used for an energy device such as a thermoelectric conversion element or for an electrical storage device such as a primary battery, secondary battery, fuel cell or capacitor.

### EXAMPLES

Hereinafter, the present invention will be explained further in detail, by way of Examples and Comparative Examples. However, the scope of the present invention is not limited to these examples.

### 1. Activating Treatment of a Solid Oxide Electrolyte

### Example 1

Under a dry atmosphere, 2 g of Li_{1.5}Al_{0.5}Ge_{1.5}(PO₄)₃ (manufactured by Kojundo Chemical Laboratory Co., Ltd.), 2 g of Li_{6.75}La₃Zr_{1.75}Nb_{0.25}O₁₂, and 15 g of ZrO₂ grinding balls (φ=5 mm) were put in a 45 mL pot made of ZrO₂. The pot was hermetically closed. Then, the pot was attached to a planetary ball mill (Planetary Mill Pulverisette 5 classic line manufactured by FRITSCH) and subjected to ball milling under the conditions of a plate rotational frequency of 300 rpm, a temperature of 25° C. and a treatment time of 30 minutes, thus obtaining a solid oxide electrolyte of Example 1.

### Comparative Example 1

A solid oxide electrolyte of Comparative Example 1 was obtained by ball milling in the same manner as Example 1, except that the treatment time was changed to 15 minutes.

### Comparative Example 2

A solid oxide electrolyte of Comparative Example 2 was obtained by grinding 2 g of Li_{1.5}Al_{0.5}Ge_{1.5}(PO₄)₃ (manufactured by Kojundo Chemical Laboratory Co., Ltd.) and 2 g of Li_{6.75}La₃Zr_{1.75}Nb_{0.25}O₁₂ in a mortar under a dry atmosphere.

### 2. Particle Size Distribution Measurement of the Solid Oxide Electrolyte

The solid oxide electrolytes of Example 1 and Comparative Examples 1 and 2 were measured for particle size distribution, by means of a particle size analyzer (manufactured by Nikkiso Co., Ltd.)

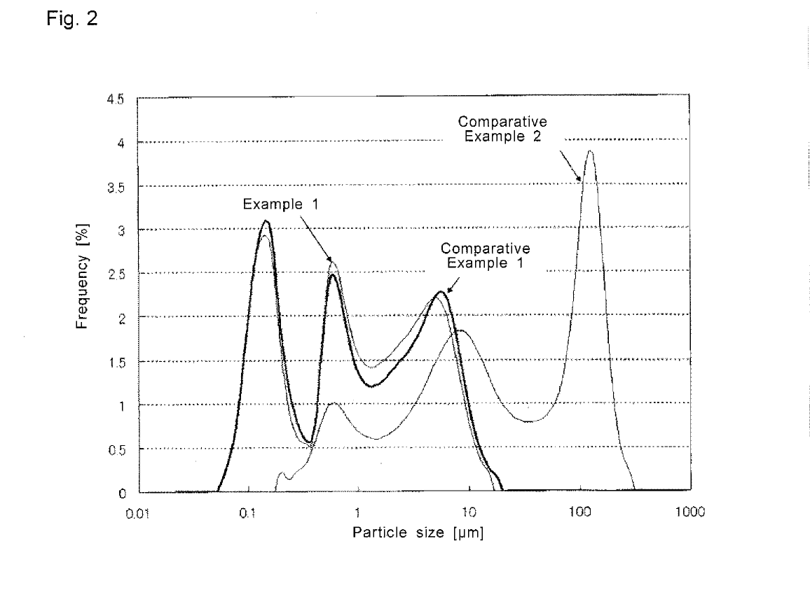

FIG. 2 is a graph comparing the results of particle size distribution measurement for the solid oxide electrolytes of Example 1 and Comparative Examples 1 and 2. FIG. 2 is a graph with logarithm of particle size (μm) on the horizontal axis and frequency (%) on the vertical axis.

As is clear from FIG. 2, in the case of the solid oxide electrolyte of Comparative Example 2, particles with a particle size on the order of 100 μm formed a majority of the electrolyte. In the case of the solid oxide electrolytes of Example 1 and Comparative Example 1, they are composed of only particles with a particle size on the order of 0.1 to 10 μm, and particles with a particle size on the order of 100 μm are not present. From this result, it is clear that the particle size of Example 1 and Comparative Example 1, both of which were subjected to ball milling, are finer than the particle size of Comparative Example 2, which was not subjected to ball milling. It is also clear from FIG. 2 that particles with a particle size on the order of less than 0.1 μm, cannot be obtained even after ball milling for 30 minutes.

### 3. Alkali Treatment of the Solid Oxide Electrolyte

Each of the solid oxide electrolytes of Example 1 and Comparative Examples 1 and 2 was put in a resin container. Then, 30 μL of 0.5 mol/L lithium hydroxide (LiOH) aqueous solution was put in the container. The solid oxide electrolyte and solution in the container were stirred for 30 minutes with a stirrer for alkali treatment of the solid oxide electrolyte. As a result, the solid oxide electrolyte and the lithium hydroxide were mixed well, thus obtaining a slurry.

The time between the ball milling and the alkali treatment was about 10 minutes.

### 4. Measurement of Activity

The alkali-treated slurries of Example 1 and Comparative Examples 1 and 2 were measured for activity by ICP-MS. The measurement device and detailed measurement conditions are as follows.

Measurement device: ICP-MS (model: SPS7800; manufactured by: Seiko Instruments, Inc.)

Carrier gas: Ar

Gas flow: 16 L/min (plasma gas), 0.8 L/min (auxiliary gas), 3.33 kgf/cm² (carrier gas), 1.0 L/min (chamber gas)

Frequency: 27.12 MHz

Maximum output: 1.2 kW

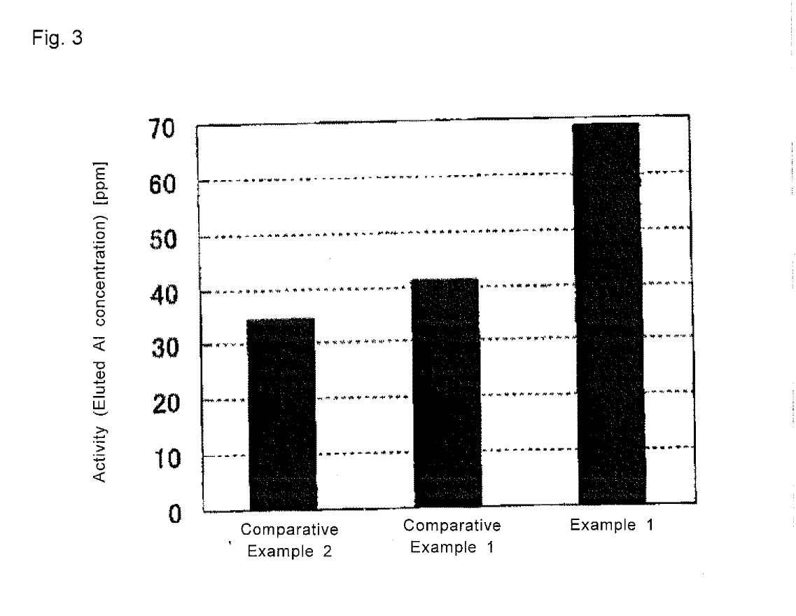

FIG. 3 is a bar graph comparing the activity of the alkali-treated slurries of Example 1 and Comparative Examples 1 and 2. FIG. 3 is a graph with activity indicator on the vertical axis, which is the concentration of aluminum eluted from the solid oxide electrolyte (ppm). Reprecipitation is promoted as the concentration of aluminum eluted from the surface and so on of non-crystalline parts of the solid oxide electrolyte increases. In this case, therefore, activity is considered to be high.

According to FIG. 3, the concentration of aluminum eluted from the solid oxide electrolyte of Comparative Example 2 is 34.6 ppm. The concentration of aluminum eluted from the solid oxide electrolyte of Comparative Example 1 is 40.9 ppm. On the other hand, the concentration of aluminum eluted from the solid oxide electrolyte of Example 1 is 68.1 ppm, and this result is about 30 ppm higher than the results of Comparative Examples 1 and 2. Accordingly, it is clear that the solid oxide electrolyte of Example 1, which was subjected to ball milling for 30 minutes, is significantly higher in activity than the solid oxide electrolyte of Comparative Example 1, which was subjected to ball milling for 15 minutes, and the solid oxide electrolyte of Comparative Example 2, which was not subjected to ball milling.

It is clear from the results shown in FIG. 2 that there is particularly no difference between the solid oxide electrolytes of Example 1 and Comparative Example 1, in terms of particle size distribution. Therefore, it is thought that the difference in ball mill treatment time (15 minutes) between Example 1 and Comparative Example 1, contributed to higher non-crystallization of the solid oxide electrolyte surface and to the increase in activity, rather than to grinding the solid oxide electrolyte finer.

### 5. Casting and Drying of the Solid Oxide Electrolyte

### Example 2

The alkali-treated slurry of Example 1 was poured into a φ15 mm mold and then pressed by a uniaxial pressing machine, in the conditions of a press pressure of 8.5 kN/cm² and a pressing time of one minute. As a result, a solid oxide electrolyte with φ15 mm and a thickness of 2 mm was obtained.

Next, the casted solid oxide electrolyte was wrapped in a polyvinylidene chloride film (trade name: Saran Wrap; manufactured by: Asahi Kasei Home Products Corporation) so as not to incorporate impurities into the electrolyte. Then, the solid oxide electrolyte was dried and completely solidified at ordinary temperature (15 to 30° C.) and under the air for 72 hours. No drying equipment such as drier was used for drying the solid oxide electrolyte.

### Example 3

The alkali-treated slurry of Example 1 was poured into a φ15 mm mold and then pressed by a uniaxial pressing machine, in the same manner as Example 2. After the uniaxial pressing, the solid oxide electrolyte was further pressed by a CIP machine (product name: DR. CIP; manufactured by KOBELCO) in the conditions of a press pressure of 200 MPa and a pressing time of one minute.

Next, the casted solid oxide electrolyte was wrapped in a polyvinylidene chloride film (trade name: Saran Wrap; manufactured by: Asahi Kasei Home Products Corporation) so as not to incorporate impurities into the electrolyte. Then, the solid oxide electrolyte was pre-dried under the conditions of a temperature of 25° C. and a humidity of 60 to 80%, for 72 hours. Finally, the solid oxide electrolyte was dried and completely solidified at ordinary temperature (15 to 30° C.) and under the air for 72 hours. No drying equipment such as drier was used for drying the solid oxide electrolyte.

### Comparative Example 3

Casting and drying were conducted in the same manner as Example 2, except that the alkali-treated slurry of Comparative Example 2 was used in place of the alkali-treated slurry of Example 1.

### 6. Evaluation of the Solid Oxide Electrolyte

### 6-1. SEM Observation

The dried solid oxide electrolytes of Example 2, Example and Comparative Example 3, were observed with a scanning electron microscope (hereinafter may be referred to as SEM).

The SEM observation conditions are as follows. That is, SEM observation was conducted by means of a scanning electron microscope (JSM6610LA manufactured by JEOL, Ltd.) at an accelerating voltage of 20 kV and a magnification of 2,500 to 10,000 times.

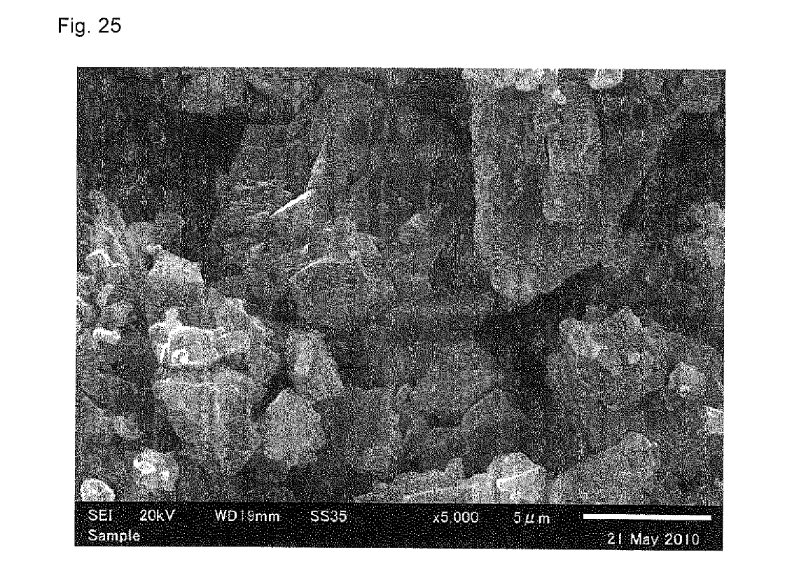

FIG. 25 is an SEM image of the dried solid oxide electrolyte of Comparative Example 3. As is clear from FIG. 25, in Comparative Example 3, many cracks are found between the crystals of the solid oxide electrolyte. The reason is thought to be as follows: the alkali-treated slurry used in Comparative Example 3 (that is, the alkali-treated slurry of Comparative Example 2) was not produced through any mechanical milling, and the amount of electrolyte eluted by the alkali treatment was small; therefore, the amount of electrolyte reprecipitated by the drying was also small and failed to sufficiently connect the solid oxide electrolyte crystals.

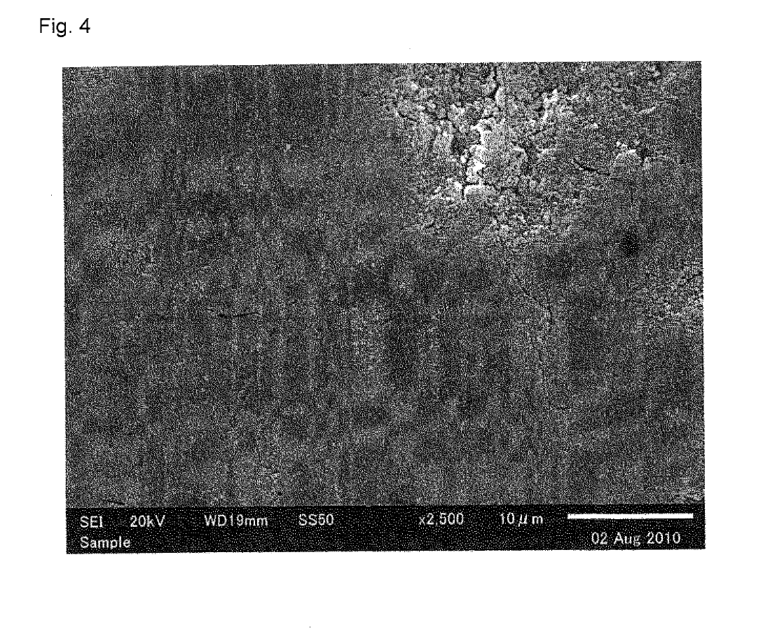

FIG. 4 is an SEM image of the dried solid oxide electrolyte of Example 2. As is clear from FIG. 4, in Example 2, the solid oxide electrolyte surface is an approximately flat surface. The reason is thought to be as follows: the alkali-treated slurry used in Example 2 (that is, the alkali-treated slurry of Example 1) was produced through the mechanical milling of 30 minutes, and the amount of electrolyte eluted by the alkali treatment was large; therefore, the amount of electrolyte reprecipitated by the drying was also large and succeeded in sufficiently connecting the solid oxide electrolyte crystals.

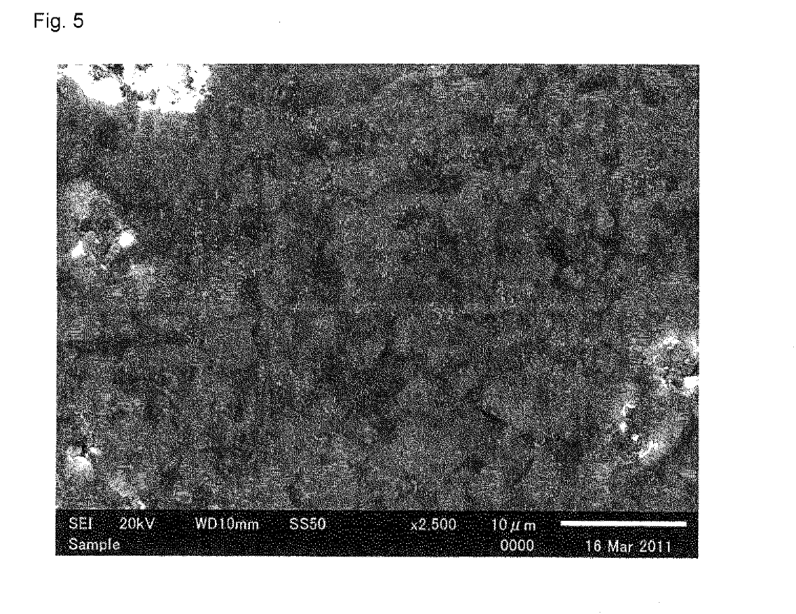

FIG. 5 is an SEM image of the dried solid oxide electrolyte of Example 3. As is clear from FIG. 5, pores or the like are not found in Example 3. The reason is thought to be as follows: the alkali-treated slurry used in Example 3 (that is, the alkali-treated slurry of Example 1) was prepared through the mechanical milling of 30 minutes, and in Example 3, after the uniaxial pressing, the slurry was further subjected to CIP; therefore, there was an increase in crystal density, which resulted in the elimination of pores.

### 6-2. Measurement of Compactness

The dried solid oxide electrolytes of Example 2 and Comparative Example 3 were measured for compactness.

First, each dried solid oxide electrolyte formed into a pellet was subjected to flat and mirror finishing, using a precision surface polishing machine (product name: Handy Lap HLA-2; manufactured by JEOL, Ltd.) Next, the diameter and thickness of the pellet was measured by a caliper.

The mass of the pellet was measured by a high-precision tuning fork electronics balance (model: U3-H12000; manufactured by: Ishida Co., Ltd.) From the diameter, thickness and mass thus measured, the density was calculated. From the density, the compactness was calculated.

The compactness of Example 2 measured by the above method, was 77.1%. The compactness of Comparative Example 3 measured by the above method, was 64.5%. Therefore, the compactness of Example 2 produced through ball milling, is significantly higher than that of Comparative Example 3 produced not through ball milling.

### 6-3. Impedance Measurement

Impedance measurement was performed on the dried solid oxide electrolytes of Examples 2 and 3. It was conducted by means of a potentio/galvanostat (model: SI1287 manufactured by: TOYO Corporation) and a multiplexer (1281 MULTIPLEXER) under the conditions of a voltage of 10 mV and a frequency of 0.1 to 1 MHz, under the air.

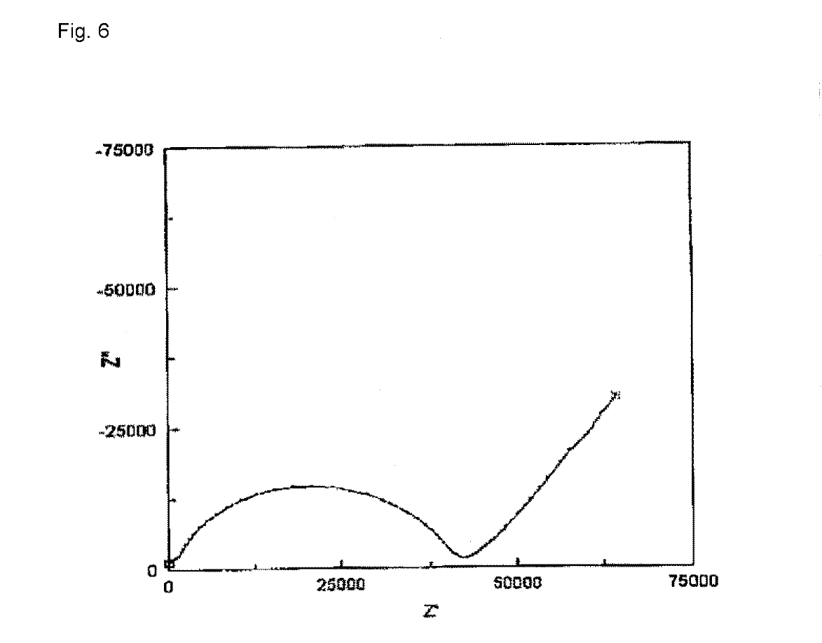

FIG. 6 is a graph showing the result of impedance measurement for the dried solid oxide electrolyte of Example 2. From FIG. 6, the lithium ion conductivity is calculated to be 2.46×10⁻⁶ (S/cm). It is clear that this lithium ion conductivity is much higher than the lithium ion conductivity of Comparative Example 3 (1.89×10⁻⁷ (S/cm)) and that of a solid oxide electrolyte produced by a conventional casting method (3×10⁻⁹ (S/cm)).

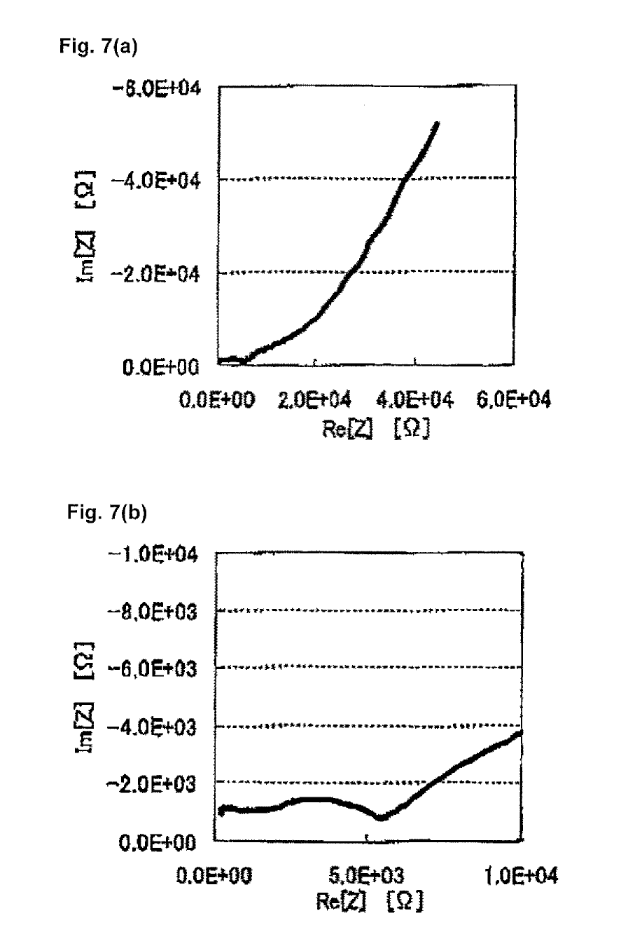

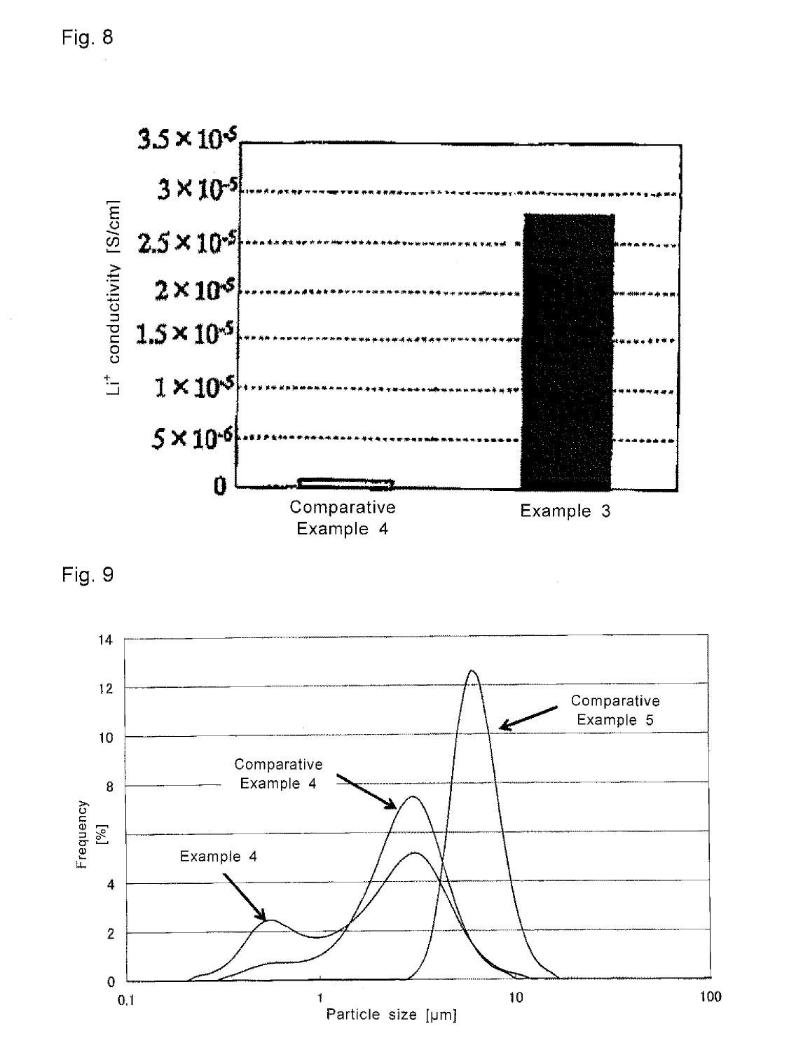

FIG. 7(a) is a graph showing the result of impedance measurement for the dried solid oxide electrolyte of Example 3. FIG. 7(b) is an enlarged view of FIG. 7(a). FIG. 8 is a bar graph comparing the lithium ion conductivity of the solid oxide electrolyte obtained by a conventional non-sintering solidification method (hereinafter referred to as of Comparative Example 4) with that of the dried solid oxide electrolyte of Example 3. From FIG. 7(b), the resistance is calculated to be 3,750 (Ω), and the lithium ion conductivity is calculated from 2.78×10⁻⁵ (S/cm). As is clear from FIG. 8, this lithium ion conductivity is 40 times higher than the lithium ion conductivity of Comparative Example 4 (6.89×10⁻⁷ (S/cm)) and is much higher than conventional.

### 7. Preparation of an Electrode Active Material

### Example 4

Under a dry atmosphere, 2 g of LiCoO₂ and 15 g of ZrO₂ grinding balls (φ=5 mm) were put in a 45 mL pot made of ZrO₂. The pot was hermetically closed. Then, the pot was attached to a planetary ball mill (Planetary Mill Fulverisette 5 classic line manufactured by FRITSCH) and subjected to ball milling under the conditions of a plate rotational frequency of 300 rpm, a temperature of 25° C. and a treatment time of 300 minutes, thus obtaining an electrode active material of Example 4.

### Example 5

An electrode active material of Example 5 was obtained in the same manner as Example 4, except that LiCoO₂ removed from the planetary ball mill was heated in a tubular furnace under an argon atmosphere, in a temperature condition of 800° C. for 5 hours.

### Comparative Example 4

An electrode active material of Comparative Example 4 was obtained in the same manner as Example 4, except that the ball mill treatment time was changed to 30 minutes.

### Comparative Example 5

An electrode active material of Comparative Example 5 was obtained by grinding 2 g of LiCoO₂ in a mortar under a dry atmosphere.

### 8. Particle Size Distribution Measurement of the Electrode Active Material

The electrode active materials of Examples 4 and 5 and Comparative Examples 4 and 5 were measured for particle size distribution, by means of a particle size analyzer (manufactured by Nikkiso Co., Ltd.)

FIG. 9 is a graph comparing the results of particle size distribution measurement for the electrode active materials of Example 4 and Comparative Examples 4 and 5. FIG. 9 is a graph with logarithm of particle size (μm) on the horizontal axis and frequency (%) on the vertical axis.

As is clear from FIG. 9, the electrode active material of Comparative Example 5 is composed of only particles with a particle size on the order of 1 to 10 μm. In the case of the electrode active materials of Example 4 and Comparative Example 4, they are composed of only particles with a particle size on the order of 0.1 to 1 μm and almost no particles with a particle size on the order of 10 μm, are present. From this result, it is clear that the particle size of Example 4 and Comparative Example 4, both of which were subjected to ball milling, are finer than the particle size of Comparative Example 5, which was not subjected to ball milling. As is clear from the comparison between Example 4 and Comparative Example 4, by extending the mechanochemical treatment time, there is an increase in the number of finer particles with a particle size on the order of less than 1 μm.

In the particle size distribution of electrode active material, particles with a particle size on the order of 1 μm or more, are particles that are unlikely to be solidified. On the other hand, particles with a particle size on the order of less than 1 μm can be solidified. When the frequency distribution of particles with a particle size on the order of less than 1 μm is 20% or more in total, it is thought that such particles can be solidified.

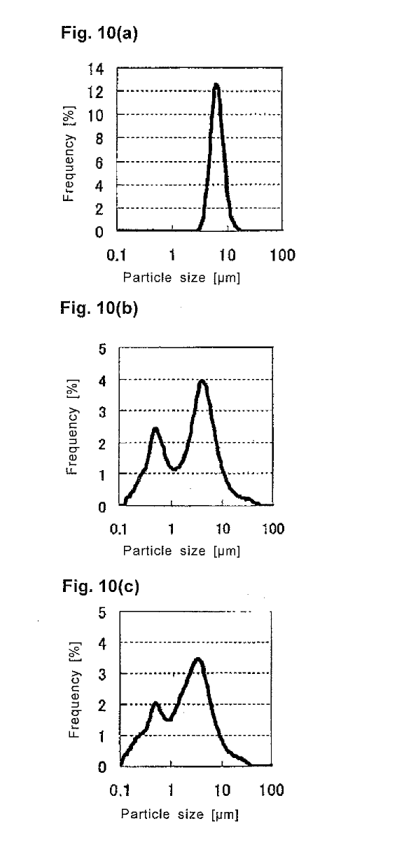

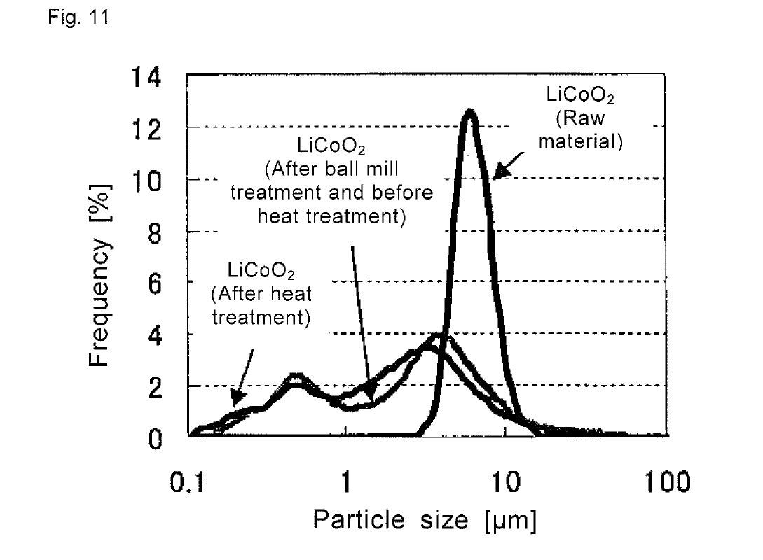

FIG. 10(a) is a graph showing the particle size distribution of LiCoO₂, which is a raw material for the electrode active material of Example 5. FIG. 10(b) is a graph showing the particle size distribution of LiCoO₂ of Example 5, after the ball mill treatment and before the heat treatment. FIG. 10(c) is a graph showing the particle size distribution of LiCoO₂ after the heat treatment. FIGS. 10(a) to 10(c) are graphs with logarithm of particle size (μm) on the horizontal axis and frequency (%) on the vertical axis. FIG. 11 is a graph obtained by stacking the particle size distributions of FIGS. 10(a) to 10(c).

As is clear from FIG. 10(a), the particle size distribution of LiCoO₂, which is a raw material, is close to normal distribution, and most of LiCoO₂ particles have a particle size in the range of 1 to 10 μm.

On the other hand, as is clear from FIG. 10(b), the particle size distribution of LiCoO₂ after the ball mill treatment and before the heat treatment, has a peak in the range of 1 to 10 μm and also in the range of 0.1 to 1 μm. As is clear from FIG. 11, most of LiCoO₂ particles, which are a raw material, were made finer by the ball mill treatment. After the ball mill treatment, part of the material was attached to the inner surface of the ball mill pot. As shown in FIG. 10(b), the reason for the appearance of two peaks in the particle size distribution after the ball mill treatment, is presumed as follows: a difference in the degree of microparticulation occurred between the material attached to the inner surface of the ball mill pot during the ball mill treatment and the material not attached to the inner surface even after the ball mill treatment, so that the material attached to the inner surface of the ball mill pot during the ball mill treatment, was not sufficiently ground in the ball mill treatment and resulted in a particle size mainly in the range of 1 to 10 μm, while the material not attached to the inner surface of the ball mill pot was sufficiently ground in the ball mill treatment and resulted in a particle size mainly in the range of 0.1 to 1 μm.

On the other hand, as is clear from FIG. 10(c), the particle size distribution of LiCoO₂ heated under the inert atmosphere, is similar to the particle size distribution of the same before the heat treatment (FIG. 10(b)) in having a peak in the range of 1 to 10 μm and also in the range of 0.1 to 1 μm; however, the overlapped area of the two peaks is smaller than the area before the heat treatment (FIG. 10(b)). This means that by the heat treatment, the particle size difference between LiCoO₂ particles was made smaller than the difference before the heat treatment.

### 9. Preparation of an Electrode Mix

### Example 6

First, 0.2 g of the solid oxide electrolyte of Example 1 and 0.25 g of the electrode active material of the Example 4 were put in a mortar and mixed for 10 minutes. No additives such as solvent were used.

Then, 50 uL of 0.5 mol/L lithium hydroxide (LiOH) aqueous solution was added to 1 g of the thus-obtained mixture and mixed for 10 minutes for alkali treatment of the mixture. As a result, the mixture and the lithium hydroxide were mixed well, thus obtaining a slurry. The time between the ball milling and the alkali treatment was about 10 minutes.

The alkali-treated mixture slurry was poured into a pellet dice and then uniaxially pressed by a Newton pressing machine, in the conditions of a press pressure of 10 to 30 MPa and a pressing time of one minute. As a result, an electrode mix with a thickness of 1,500 μm was obtained.

The uniaxially-pressed electrode mix was vacuum-packed and then further pressed by a CIP machine (product name: DR. CIP; manufactured by KOBELCO) in the conditions of a press pressure of 392 MPa and pressing time of one minute. By this CIP, lithium hydroxide was spread through the whole mixture.

After the CIP, the electrode mix was wrapped in a polyvinylidene chloride film (trade name: Saran Wrap; manufactured by: Asahi Kasei Home Products Corporation) so as not to incorporate impurities into the electrode mix. Then, the electrode mix was dried and completely solidified at ordinary temperature (15 to 30° C.) and under the air for 2 to 7 days. No drying equipment such as drier was used for drying the electrode mix.

The electrode mix of Example 6 was produced by the above process. FIG. 12 is an image of a solidified product of the electrode mix of Example 6.

### Example 7

An electrode mix of Example 7 was produced in the same manner as Example 6, except that 0.25 g of the electrode active material of Example 5 was used in place of 0.25 g of the electrode active material of Example 4.

### 10. SEM Observation of the Electrode Mix

The solidified electrode mix of Example 6 and that of Example 7 were subjected to SEM observation. The SEM observation conditions are as follows. That is, SEM observation was conducted by means of a scanning electron microscope (JSM6610LA manufactured by JEOL, Ltd.) at an accelerating voltage of 20 kV and a magnification of 2,500 to 10,000 times.

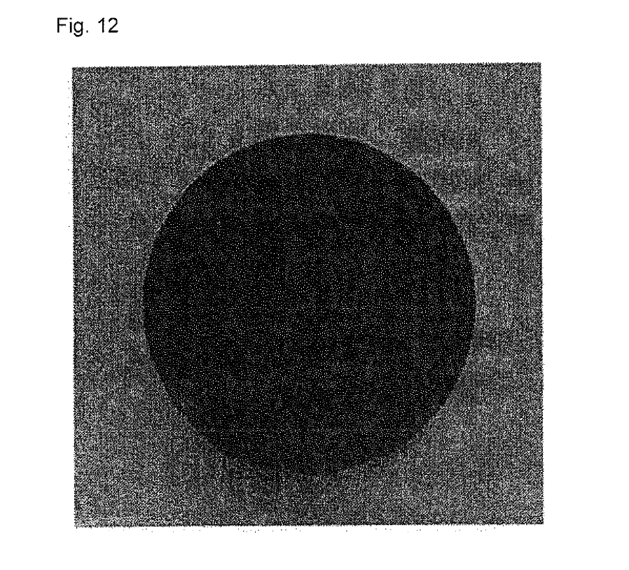

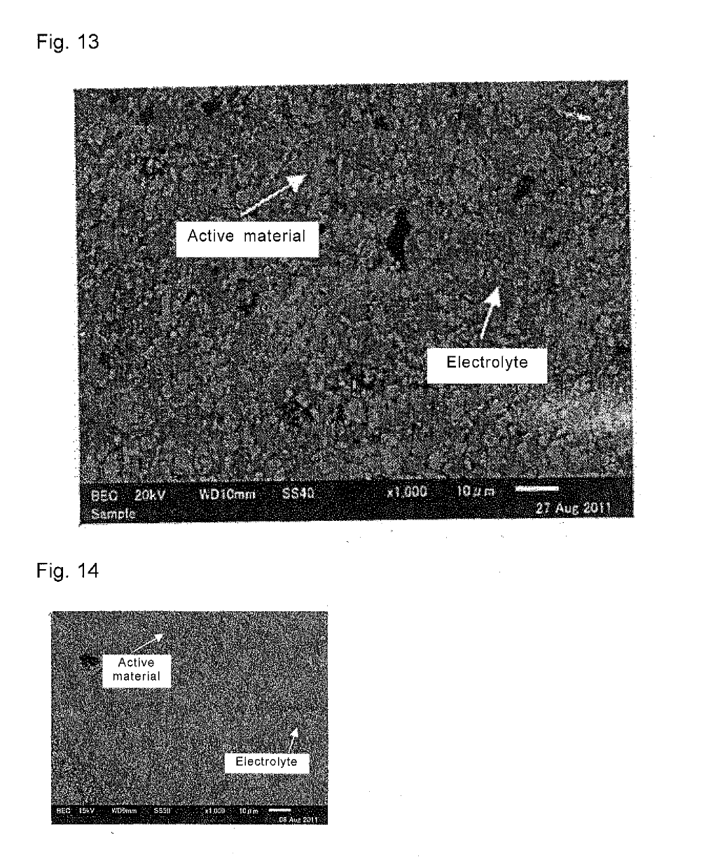

FIG. 13 is an SEM image of the dried electrode mix of Example 6. In FIG. 13, light parts indicate the presence of the electrode active material, and dark parts indicate the presence of the solid oxide electrolyte.

As is clear from FIG. 13, the surface of the electrode mix of Example 6 is an approximately flat surface. The reason is thought to be as follows: the solid oxide electrolyte used in Example 6 (that is, the solid oxide electrolyte of Example 1) was produced through the mechanical milling of 30 minutes, and the amount of vitrifiable element eluted by the alkali treatment was large; therefore, the amount of glass reprecipitated by the drying was also large and succeeded in sufficiently connecting crystals which constitute the electrode mix.

As is also clear from FIG. 13, almost no pores or the like are found in Example 6. The reason is thought to be as follows: after the uniaxial pressing, the mixture prepared through the mechanical milling was further subjected to CIP; therefore, there was an increase in crystal density, which resulted in the elimination of pores.

As is further clear from FIG. 13, the electrode active material and the solid oxide electrolyte are mixed densely and almost uniformly.

FIG. 14 is an SEM image of the dried electrode mix of Example 7. In FIG. 14, light parts indicate the presence of the electrode active material, and dark parts indicate the presence of the solid oxide electrolyte.

As is clear from FIG. 14, the surface of the electrode mix of Example 7 is an approximately flat surface. The reason is thought to be as follows: the solid oxide electrolyte used in Example 7 (that is, the solid oxide electrolyte of Example 1) was produced through the mechanical milling of 30 minutes, and the amount of vitrifiable element elated by the alkali treatment was large; therefore, the amount of glass reprecipitated by the drying was also large and succeeded in sufficiently connecting crystals which constitute the electrode mix.

As is also clear from FIG. 14, almost no pores or the like are found in Example 7. The reason is thought to be as follows: after the uniaxial pressing, the mixture prepared through the mechanical milling was further subjected to CIP; therefore, there was an increase in crystal density, which resulted in the elimination of pores.

As is further clear from FIG. 14, the electrode active material and the solid oxide electrolyte are mixed densely and almost uniformly. When comparing FIGS. 14 and 13, it is clear that the surface of the electrode mix of Example 7 (FIG. 14) is finer than the surface of the electrode mix of Example 6 (FIG. 13).

### 11. Production of a Battery

### Example 8

A coin battery was produced by using a lithium-indium alloy pellet (φ13 mm, t=100 μm) as the anode, a polymer electrolyte (“ELEXCEL TA-210” manufactured by Dai-Ichi Kogyo Seiyaku Co., LTD.) and the electrode mix of Example 6 (φ13 mm, t=100 μm). First, the anode was put in an anode can, followed by a packing. On the anode, the polymer electrolyte and the electrode mix (cathode) were placed in this order. On the cathode, a current collector (SUS306) and then a washer were placed, the current collector being able to function as a spacer. The resultant was covered with a cathode can. Finally, the stack was swaged by a swaging device, thus obtaining the battery of Example 8.

### Example 9

A battery of Example 9 was produced in the same manner as Example 8, except that the electrode mix of Example 7 was used in place of the electrode mix of Example 6.

### Reference Example 1

A battery of Reference Example 1 was produced in the same manner as Example 8, except that only the electrode active material of Example 5 was used as the cathode, in place of the electrode mix of Example 6.

### Reference Example 2

A battery of Reference Example 2 was produced in the same manner as Example 8, except that only the electrode active material of Example 4 was used as the cathode, in place of the electrode mix of Example 6.

### Reference Comparative Example 1

A battery of Reference Comparative Example 1 was produced in the same manner as Example 8, except that only LiCoO₂ was used as the cathode in place of the electrode mix of Example 6.

### 12. Charge-Discharge Test

Charge-discharge test of the batteries of Example 8, Reference Example 1, Reference Example 2 and Reference Comparative Example 1 was conducted, in accordance with normal charge-discharge processes. The test conditions are as follows.

Testing machine: A charge-discharge tester (manufactured by Toyo System Co., Ltd.)

Measurement potential: 4.2 to 2.5 V

Measurement current: 101.8 μA

Atmosphere: Under the air (argon atmosphere inside the battery)

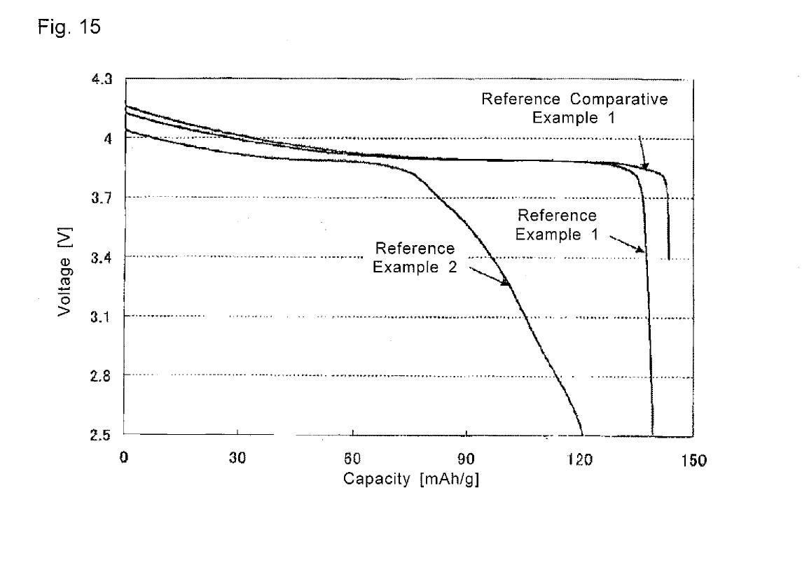

FIG. 15 is a graph showing the discharge curves of the batteries of Reference Examples 1 and 2 and Reference Comparative Example 1. FIG. 15 shows that the discharge capacity of the battery of Reference Example 1 is 139.3 mAh/g; the discharge capacity of the battery of Reference Example 2 is 120.9 mAh/g; and the discharge capacity of the battery of Reference Comparative Example 1 is 143.5 mAh/g. Accordingly, it is clear that the electrode active material used in Reference Example 1, which is the electrode active material of Example 5, and the electrode active material used in Reference Example 2, which is the electrode active material of Example 4, both show a discharge performance similar to the LiCoO₂ raw material used in Reference Comparative Example 1, even in the case where the cathode is composed only of one of these electrode active materials. Also, the electrode active material used in Reference Example 1, which is the electrode active material of Example 5, showed a higher discharge capacity than the electrode active material used in Reference Example 2, which is the electrode active material of Example 4. The reason is as follows: in Example 5, by further heating the electrode active material subjected to the ball milling, vitrified parts that appeared on the surface of the electrode active material were recrystallized, while the activation state produced by the ball milling was maintained; therefore, there was a further increase in the performance of the electrode active material, which resulted in the higher discharge capacity.

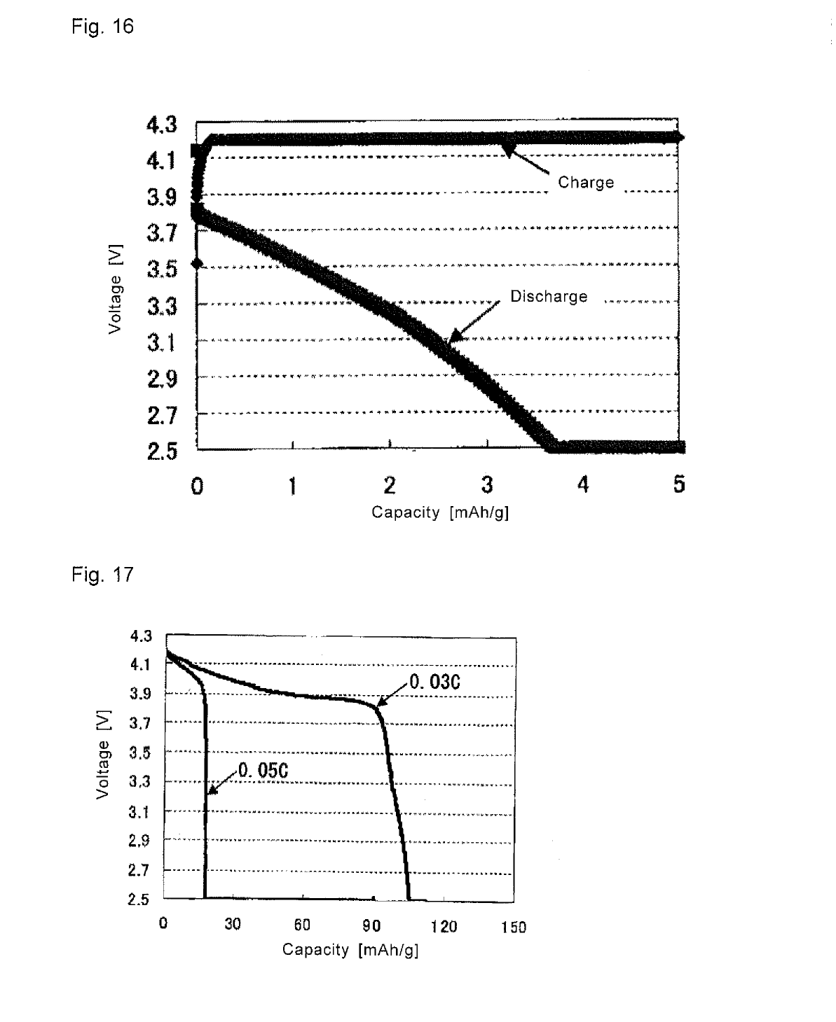

FIG. 16 is a graph showing the charge and discharge curves of the battery of Example 8. From FIG. 16, it is clear that a cathode with charge-discharge capabilities was produced by the production method of the present invention. It is also clear that the battery of Example 8 is high in discharge capacity and low in direct-current resistance and reaction resistance.

FIG. 19 is a bar graph comparing the capacity of the battery comprising a cathode mix produced by a conventional sintering method (hereinafter referred to as the battery of Comparative Example 6) with the capacity of the battery of Example 8. FIG. 19 shows that the capacity of the battery of Example 8 is 3.7 mAh/g, while the capacity of the battery of Comparative Example 6 is 7×10⁻⁴ mAh/g. Therefore, the capacity of the battery of Example 8 is about 5,300 times larger than that of the battery of Comparative Example 6, and it is clear that the battery comprising the electrode mix produced by the production method of the present invention, has an extremely higher capacity than the battery comprising the cathode mix produced by the conventional sintering method.

Charge-discharge test of the batteries of Examples 8 and 9 was conducted in the charge-discharge measurement condition of 0.03 C or 0.05 C. As used herein, “0.03 C” means a condition that the charge-discharge test is conducted at such a rate that the charge stored in a battery is reduced to 0 in 3 hours. Also, “0.05 C” means a condition that the charge-discharge test is conducted at such a rate that the charge stored in a battery is reduced to 0 in 5 hours. Other test conditions are as follows.

Testing machine: A charge-discharge tester (manufactured by Toyo System Co., Ltd.)

Measurement potential: 4.2 to 2.5 V

Measurement current: 101.8 μA

Atmosphere: Under the air (argon atmosphere inside the battery)

From the discharge curve thus obtained, the discharge capacity and usage of the electrode mix in the battery was calculated. The usage is a value obtained by dividing the discharge capacity obtained by an actual measurement by the theoretical discharge capacity per 1 g of the electrode active material.

FIG. 17 is a graph showing the discharge curves of Example 8, under the charge-discharge measurement conditions of 0.03 C and 0.05 C. In FIG. 17, each of the graphs represented as “0.03 C” and “0.05 C” indicates a discharge curve that was obtained when the charge-discharge measurement condition was 0.03 C or 0.05 C.

FIG. 17 shows that in the charge-discharge measurement condition of 0.03 C, the discharge capacity of the battery of Example 8 is 105.6 mAh/g, and the usage is 78.2%. In the charge-discharge measurement condition of 0.05 C, the discharge capacity of the battery of Example 8 is 17.5 mAh/g, and the usage is 13.0%. Therefore, it is clear that the battery of Example 8 is high in discharge capacity and usage, especially when the discharge rate is high.

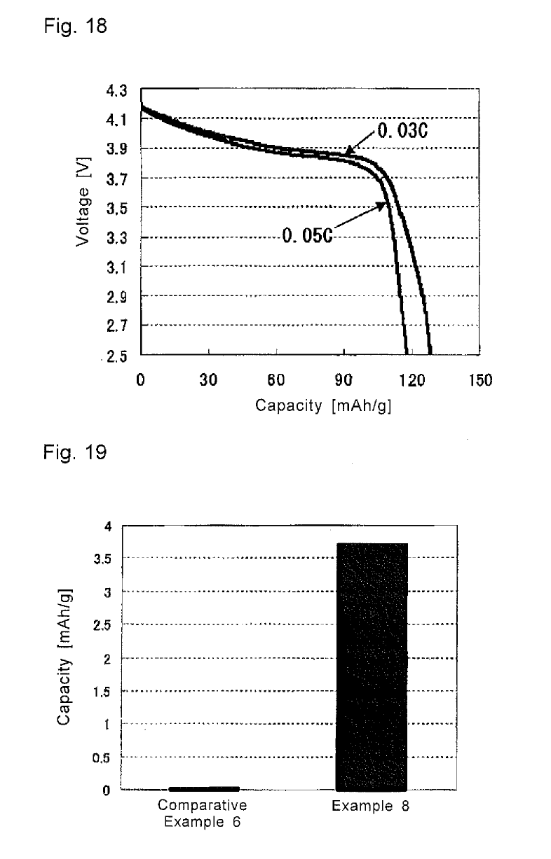

FIG. 18 is a graph showing the discharge curves of Example 9, under the charge-discharge measurement conditions of 0.03 C and 0.05 C. In FIG. 18, each of the graphs represented as “0.03 C” and “0.05 C” indicates a discharge curve that was obtained when the charge-discharge measurement condition was 0.03 C or 0.05 C.

FIG. 18 shows that in the charge-discharge measurement condition of 0.03 C, the discharge capacity of the battery of Example 9 is 128.0 mAh/g, and the usage is 94.8%. In the charge-discharge measurement condition of 0.05 C, the discharge capacity of the battery of Example 9 is 117.7 mAh/g, and the usage is 87.2%. Therefore, it is clear that the battery of Example 9 is high in discharge capacity and usage at both high and low rates.

When comparing FIGS. 17 and 18, it is clear that the battery of Example 9 is higher than the battery of Example 8 in discharge capacity and usage in both the charge-discharge measurement conditions of 0.03 C and 0.05 C. Particularly in the charge-discharge measurement condition of 0.05 C, there is a large difference between Examples 9 and 8 in discharge capacity and usage.

From the above results, it is clear that the battery comprising the electrode active material subjected to the ball mill treatment and then further to the heat treatment to recrystallize at least the surface thereof, is extremely high in discharge capacity and usage, at both high and low rates.

This Example shows the result of heating the electrode active material only. However, even in the case of heating the mixture of the electrode active material and the solid electrolyte, it is thought that the recrystallization effect of the surface of the electrode active material vitrified by the ball milling, can be obtained.

### 13. Evaluation of a Preparation Under Inert Atmosphere

13-1. Preparation of a Solid Oxide Electrolyte

### Example 10

The following process was all conducted in a glove box under a nitrogen atmosphere.

First, Li_{1.5}Al_{0.5}Ge_{1.5}(PO₄)₃ (manufactured by Kojundo Chemical Laboratory Co., Ltd.) was put in a resin container. Then, 30 μL of 0.5 mol/L lithium hydroxide (LiOH) aqueous solution was put in the container. Li_{1.5}Al_{0.5}Ge_{1.5}(PO₄)₃ and the solution were stirred for 30 minutes with a stirrer for alkali treatment of Li_{1.5}Al_{0.5}Ge_{1.5}(PO₄)₃. As a result, Li_{1.5}Al_{0.5}Ge_{1.5}(PO₄)₃ and the lithium hydroxide were mixed well, thus obtaining a slurry. The time between the ball milling and the alkali treatment was about 10 minutes.

Next, the alkali-treated slurry was poured into a φ15 mm mold and then pressed by a uniaxial pressing machine, in the conditions of a press pressure of 8.5 kN/cm² and a pressing time of one minute. As a result, a solid oxide electrolyte with φ15 mm and a thickness of 2 mm was obtained.

Nest, the casted solid oxide electrolyte was wrapped in a polyvinylidene chloride film (trade name: Saran Wrap; manufactured by: Asahi Kasei Home Products Corporation) so as not to incorporate impurities into the electrolyte. Finally, the solid oxide electrolyte was dried and completely solidified at ordinary temperature (15 to 30° C.) for 72 hours, thus producing the solid oxide electrolyte of Example 10. No drying equipment such as drier was used for drying the solid oxide electrolyte.

### Reference Example 3

A solid oxide electrolyte of Reference Example 3 was produced in the same manner as Example 10, except that the production process was all conducted under the air atmosphere.

### 13-2. Preparation of an Electrode Mix

### Example 11

The following process was all conducted in a glove box under an argon atmosphere.

First, 0.2 g of Li_{1.5}Al_{0.5}Ge_{1.5}(PO₄)₃ (manufactured by Kojundo Chemical Laboratory Co., Ltd.) and 0.25 g of the electrode active material of Example 4 were put in a mortar and mixed for 10 minutes. No additives such as solvent were used.

Then, 50 μL of 0.5 mol/L lithium hydroxide (LiOH) aqueous solution was added to 1 g of the thus-obtained mixture and mixed for 10 minutes for alkali treatment of the mixture. As a result, the mixture and the lithium hydroxide were mixed well, thus obtaining a slurry. The time between the ball milling and the alkali treatment was about 10 minutes.

The alkali-treated mixture slurry was poured into a pellet dice and then uniaxially pressed by a Newton pressing machine, in the conditions of a press pressure of 10 to 30 MPa and a pressing time of one minute. As a result, an electrode mix with a thickness of 1,500 μm was obtained.

The uniaxially-pressed electrode mix was vacuum-packed and then further pressed by a CIP machine (product name: DR. CIP; manufactured by KOBELCO) in the conditions of a press pressure of 392 MPa and pressing time of one minute. By this CIP, lithium hydroxide was spread through the whole mixture.

After the CIP, the electrode mix was wrapped in a polyvinylidene chloride film (trade name: Saran Wrap; manufactured by: Asahi Kasei Home Products Corporation) so as not to incorporate impurities into the electrode mix. Then, the electrode mix was dried and completely solidified at ordinary temperature (15 to 30° C.) for 2 to 7 days. No drying equipment such as drier was used for drying the electrode mix.

The electrode mix of Example 11 was produced by the above process.

### 13-3. TEM Observation

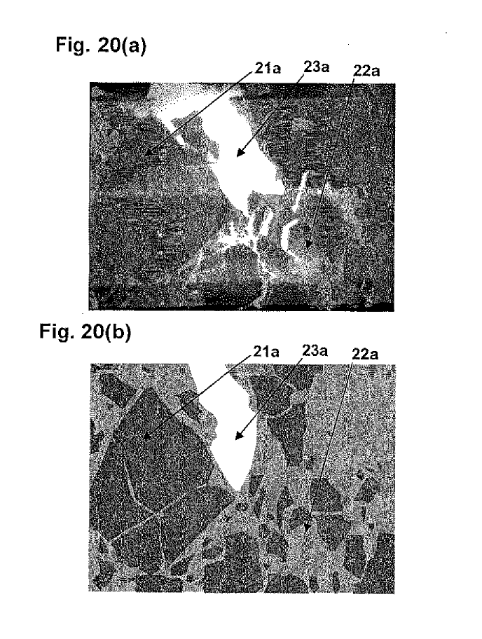

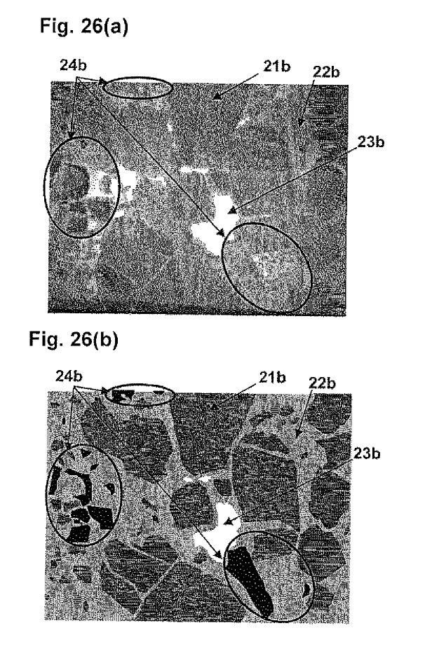

FIG. 20 shows a TEM image of the solid oxide electrolyte of Example 10 (FIG. 20(a)) and a schematic view (FIG. 20(b)) representing the composition distribution inside the solid oxide electrolyte, based on the TEM image. FIG. 26 shows a TEM image of the solid oxide electrolyte of Reference Example 3 (FIG. 26(a)) and a schematic view (FIG. 26(b)) representing the composition distribution inside the solid oxide electrolyte, based on the TEM image.

As is clear from FIG. 26(b), the solid oxide electrolyte of Reference Example 3 contains a gray crystal part 21b, a light gray glass part 22b and black impurities 24b. Meanwhile, as is clear from FIG. 20(b), the solid oxide electrolyte of Example 10 contains a gray crystal part 21a and a light gray glass part 22a; however, the solid oxide electrolyte does not contain other impurities at all.

A white area 23a in FIGS. 20(a) and 20(b) indicates a pore. A white area 23b in FIGS. 26(a) and 26(b) also indicates a pore.

### 13-4. XRD Measurement

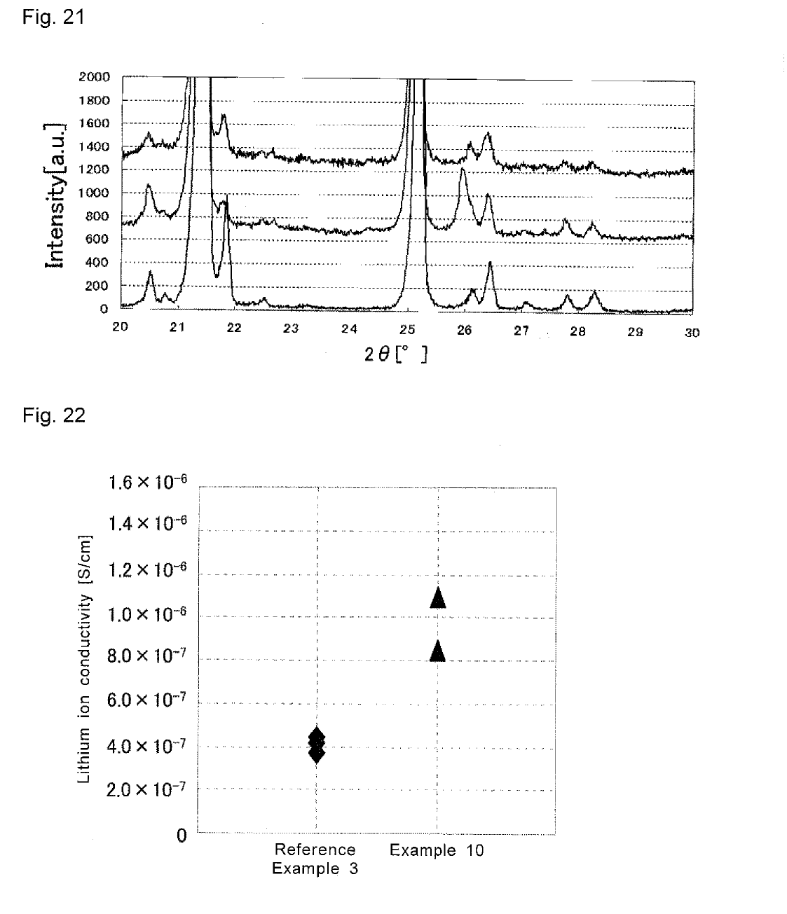

FIG. 21 is a graph showing the XRD spectrum of the solid oxide electrolyte of Example 10, the XRD spectrum of the solid oxide electrolyte of Reference Example 3, and the XRD spectrum of Li_{1.5}Al_{0.5}Ge_{1.5}(PO₄)₃, which is a material for the two solid oxide electrolytes. The three spectra shown in FIG. 21 are, stating from the top, the XRD spectrum of the solid oxide electrolyte of Example 10, the XRD spectrum of the solid oxide electrolyte of Reference Example 3, and the XRD spectrum of Li_{1.5}Al_{0.5}Ge_{1.5}(PO₄)₃.

It is clear from FIG. 21 that in the XRD spectrum of Reference Example 3, a peak appears at 2θ=26°. This peak at 2θ=26° is a peak that indicates the presence of germanium dioxide (GeO₂). In the XRD spectra of Example 10 and Li_{1.5}Al_{0.5}Ge_{1.5}(PO₄)₃, no peak appears at 28Θ=26°.

From the above, it is clear that in the case of conducting the alkali treatment under the air atmosphere, at least by-product germanium dioxide (GeO₂) is produced in the solid oxide electrolyte as an impurity; meanwhile, in the case of conducting the alkali treatment under the inert atmosphere, such by-product impurities including an oxide are not produced in the solid oxide electrolyte.

### 13-5. Impedance Measurement

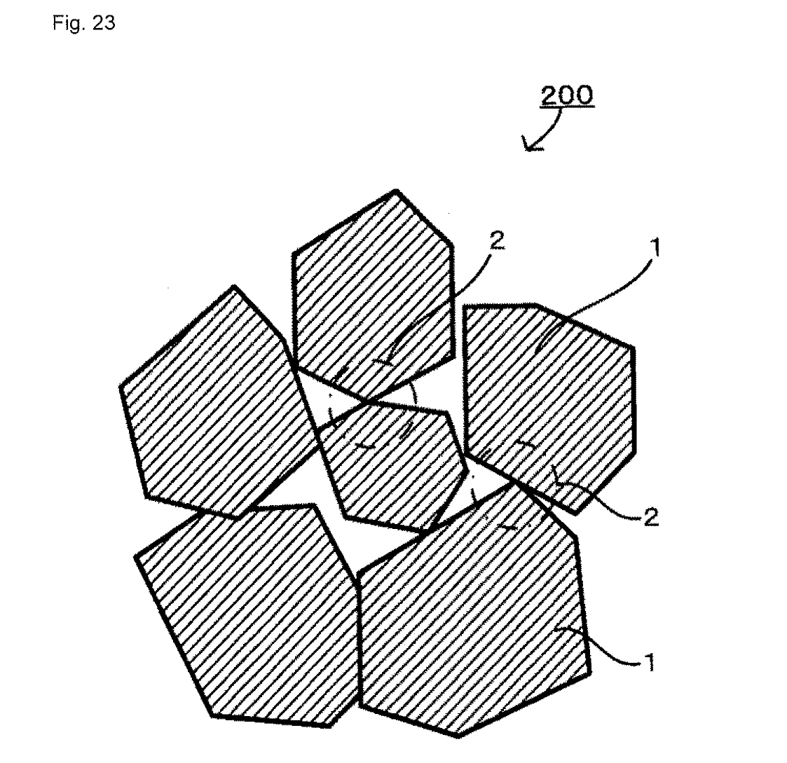

Impedance measurement was performed three times on each of the solid oxide electrolytes of Example 10 and Reference Example 3 to measure the lithium ion conductivity of the solid oxide electrolytes. FIG. 22 is a graph showing the lithium ion conductivity of the solid oxide electrolyte of Example 10 and that of the solid oxide electrolyte of Reference Example 3. The reason why there are two plots in connection with Example 10, is that two of the results of the lithium ion conductivity measurement are equal.

FIG. 22 shows that the average lithium ion conductivity of Example 10 is 1.0×10⁻⁶ (S/cm), while the average lithium ion conductivity of Reference Example 3 is 4.1×10⁻⁷ (S/cm). Therefore, it is clear that the lithium ion conductivity of the solid oxide electrolyte of Example 10, which contains no impurities such as an oxide, is 2.4 times higher than the lithium ion conductivity of the solid oxide electrolyte of Reference Example 3, which contains at least germanium dioxide as an impurity.

### Reference Signs List

1. Solid crystal
2. Contact point
3. Mixture of a basic material and a raw material eluted from crystal
4. Reprecipitated raw material
21a, 21b. Crystal part of a solid oxide electrolyte
22a, 22b. Glass part of a solid oxide electrolyte
23a, 23b. Pore
24b. Impurities contained in a solid oxide electrolyte
100, 200. Solid crystal film

1. A method for producing a material for at least any one of an energy device and an electrical storage device, the method comprising:
an alkali treatment step of bringing a raw material comprising a vitrifiable element and having a chemical composition represented by the following formula (1) or (2) into contact with a basic material:
Li₁₊ₓAlₓGe₂₋ₓ(PO₄)₃ (wherein 0<x≦1) Formula (1):
Li_{y}La₃(Zr_{1-z}Nb_{z})₂O₁₂ (wherein 0<y≦10 and 0≦z<1) Formula (2):
and
a solidifying step of dehydration-condensation of the raw material in a temperature condition of 15 to 30° C. after the alkali treatment step.

2. The method according to claim 1, further comprising the step of performing a mechanochemical treatment on the raw material before the alkali treatment step.

3. The method according to claim 2, wherein the mechanochemical treatment step is a step in which ball mill treatment is used.

4. The method according to claim 1, wherein the alkali treatment step is a step of immersing the raw material comprising a vitrifiable element in an aqueous solution of at least one kind of lithium-containing basic material selected from the group consisting of LiOH, CH₃COOLi, Li₂CO₃ and LiAlO₂.

5. The method according to claim 1, further comprising the step of applying the alkali-treated raw material to a predetermined substrate after the alkali treatment step and before the solidification step.

6. The method according to claim 5, further comprising the step of cold isostatic pressing the raw material applied to the substrate, after the application step and before the solidification step.

7. The method according to claim 6, further comprising the step of pre-drying the pressed raw material after the cold isostatic pressing step and before the solidification step.

8. The method according to claim 1, further comprising the step of mixing the alkali-treated raw material and a non-crystalline binder before the solidification step,
wherein the mixture of the alkali-treated raw material and the non-crystalline binder is solidified in a temperature condition of 15 to 30° C. at the solidification step.

9. The method according to claim 1, wherein the vitrifiable element is an element selected from the group consisting of boron, aluminum, silicon, phosphorus, vanadium, germanium, arsenic, zirconium and antimony.

10-31. (canceled)
